(19) United States
(12) Patent Application Publication
(10) Pub. No.: US 2013/0215919 A1
(43) Pub. Date: Aug. 22, 2013

(54) WIDEBAND TUNABLE LASER LINE-WIDTH REDUCTION

(71) Applicant: UNIVERSITY OF SOUTHERN CALIFORNIA, (US)

(72) Inventors: Firooz Aflatouni, Pasadena, CA (US); Hossein Hashemi, Pacific Palisades, CA (US)

(73) Assignee: UNIVERSITY OF SOUTHERN CALIFORNIA, Los Angeles, CA (US)

(21) Appl. No.: 13/770,831

(22) Filed: Feb. 19, 2013

Related U.S. Application Data
(60) Provisional application No. 61/600,509, filed on Feb. 17, 2012.

(51) Int. Cl. H01S 3/13

(52) U.S. Cl. CPC H01S 3/1307
USPC 372/38.01; 372/38.08

(57) ABSTRACT

Various examples of feed-forward systems that reduce phase noise in a laser field generated by a laser. These include feed-forward systems that utilize phase and/or frequency discriminators, filters, integrators, voltage controlled oscillators (VCOs), current controlled oscillators (CCOs), phase modulators, and/or amplitude modulators. It also includes systems that use both feed-forward and feedback phase noise reduction systems, tunable semiconductor lasers, and multiple, sequential feed-forward systems.

### CROSS-REFERENCE TO RELATED APPLICATION

This application is based upon and claims priority to U.S. provisional patent application 61/600,509, entitled “WIDEBAND TUNABLE LASER LINE-WIDTH REDUCTION SCHEME,” filed Feb. 17, 2012, attorney docket number 028080-0709. The entire content of this application is incorporated herein by reference.

### STATEMENT REGARDING FEDERALLY SPONSORED RESEARCH

This invention was made with government support under Grant No. 0846482, awarded by the National Science Foundation. The Government has certain rights in the invention.

### BACKGROUND

1. Technical Field

This disclosure relates to phase noise in laser fields produced by semiconductor lasers and to devices that reduce that phase noise.

2. Description of Related Art

A laser with low phase noise may be useful in many applications, such as coherent optical communication, see E. Patzak and P. Meissner, “Influence of IF-filtering on bit error rate floor in coherent optical DPSK-systems,” IEE Optoelectron., vol. 135, no. 5, pp. 355-358, October 1988, K. Gao, J. Wang, L. Yang, X. He, D. Peterson, and Z. Pan, “Local oscillator linewidth limitation on 16 QAM coherent optical transmission system,” IEEE-OSA CLEO, no. JThE64, 2010; interferometric sensing, see L. Stolpner, S. Lee, S. Li, A. Mehnert, P. Mols, S. Siala, and J. Bush, “Low noise planar external cavity laser for interferometric fiber optic sensors,” SPIE, vol. 7004, no. 2, pp. 700457 1-700457.4, 2008; LIDAR, see M. C. Amann, “Phase noise limited resolution of coherent LIDAR using widely tunable laser diodes,” Electron. Lett., vol. 28, no. 78, August 1992; and mm-wave signal generation, see J. Yao, “Microwave photonics,” J. Lightw. Technol., vol. 27, no. 3, pp. 314-335, February 2009, P. Dowd, I. H. White, M. R. T. Tan, and S. Y. Wang, “Linewidth narrowed vertical-cavity surface-emitting lasers for millimeter-wave generation by optical heterodyning,” IEEE J. Sel. Topics Quantum Electron., vol. 3, no. 2, pp. 405-408, April 1997. A narrow linewidth laser may enable realizations of complex and efficient phase modulation schemes in the optical domain. They may combine the sophistication and bandwidth efficiency of the signals in the electrical domain with the simplicity, low loss data transfer, and ultrahigh data rate capacity in the optical domain.

Linewidth reduction from 5 MHz to 500 KHz may reduce the estimated bit error rate (BER) of a 16-QAM scheme, see K. Gao, J. Wang, L. Yang, X. He, D. Peterson, and Z. Pan, “Local oscillator linewidth limitation on 16 QAM coherent optical transmission system,” IEEE-OSA CLEO, no. JThE64, 2010, from 2×10⁻³ to about 1.5×10⁻⁵ when a 40 Gb/s signal is transmitted over a 315-km range. Also, linewidth reduction from 10 to 1 MHz may improve the estimated resolution of the coherent LIDAR, as discussed in M. C. Amann, “Phase noise limited resolution of coherent LIDAR using widely tunable laser diodes,” Electron. Lett., vol. 28, no. 78, August 1992, from about 60 to about 20 m (for a 10-m range).

Laser linewidth reduction techniques using optical feedback have been demonstrated where a small amount of light is fed back into the laser after being filtered by a high quality factor resonator. See B. Dahmani, L. Hollberg, and R. Drullinger, “Frequency stabilization of semiconductor lasers by resonant optical feedback,” Opt. Lett., vol. 12, no. 11, pp. 876-878, 1987; P. Laurent, A. Clairon, and C. Bréant, “Frequency noise analysis of optically self-locked diode lasers,” IEEE J. Quantum Electron., vol. 25, no. 6, pp. 1131-1142, 1989; C. H. Shin, M. Teshima, M. Ohtsu, T. Imai, J. Yoshida, and K. Nishide, “FM characteristics and compact modules for coherent semiconductor lasers coupled to an external cavity,” IEEE Photon. Technol. Lett., vol. 2, no. 3, pp. 167-169, 1990; and H. Stoehr, F. Mensing, J. Helmcke, and U. Sterr, “Diode laser with 1 Hz linewidth,” Opt. Lett., vol. 31, no. 6, pp. 736-738, 2006. Electrical feedback is another method to improve laser spectral purity where the frequency fluctuations of the laser are converted to intensity variations by a frequency discriminator. The resulting signal may be photodetected and fed back to the laser through its bias current, see M. Ohtsu and S. Kotajima, “Linewidth reduction of a semiconductor laser by electrical feedback,” IEEE J. Quantum Electron., vol. 21, no. 12, pp. 1905-1912, 1985; M. Ohtsu, M. Murata, and M. Kourogifm, “Noise reduction and subkilohertz linewidth of an AlGaAs laser by negative electrical feedback,” IEEE J. Quantum Electron., vol. 26, no. 2, pp. 231-241, February 1990; M. Kourogi, C. H. Shin, and M. Ohtsu, “A 250 Hz spectral linewidth 1.5 prn MQW-DFB laser diode with negative-electrical-feedback,” IEEE Photon. Technol. Lett., vol. 3, no. 6, pp. 496-498, June 1991; and J. F. Cliche, Y. Painchaud, C. Latrasse, M. J. Picard, I. Alexandre, and M. Têtu, “Ultra-narrow brag grating for active semiconductor laser linewidth reduction through electrical feedback,” in Proc. Bragg Grating Photosens. Poling Conf., 2007, paper BTuE2, or to an external optical modulator following the laser, see M. S. Taubman and J. L. Hall, “Cancellation of laser dither modulation from optical frequency standards,” Opt. Lett., vol. 25, no. 5, pp. 311-313, 2000. A combination of optical and electrical feedback methods has been used to further reduce the laser linewidth, see C. H. Shin and M. Ohtsu, “Stable semiconductor laser with a 7-Hz linewidth by an optical-electrical double-feedback technique,” Opt. Lett., vol. 15, no. 24, pp. 1455-1457, 1990.

Although optical feedback may have wideband noise suppression characteristics, electrical feedback may be superior to optical feedback with respect to reproducibility and stability. See M. Ohtsu and N. Tabuchi, “Electrical feedback and its network analysis for linewidth reduction of a semiconductor laser,” J. Lightw. Technol., vol. 5, pp. 357-369, March 1988. Also, linewidth reduction using electrical feedback methods may achieve lower frequency noise and narrower spectral linewidth than those of optical feedback schemes because of a larger feedback gain that can be realized in the electrical domain. The amount of phase noise reduction using electrical/optical feedback methods depends on loop gain; and a larger loop gain may result in more phase noise cancellation. However, there may be a tradeoff between the amount of phase noise reduction (corresponding to the loop gain) and the bandwidth over which, in presence of the feedback loop delay, a stable feedback system can operate. Another drawback of feedback techniques in laser phase noise reduction may be the dependency of the scheme on the characteristics of the laser source (semiconductor laser, gas laser, etc.), as the laser source may be part of the feedback loop. For instance, an abrupt phase drop in the FM response of semiconductor lasers may limit the feedback bandwidth, and therefore the cancellation bandwidth, to sub-megahertz range.

An alternative method to a feedback scheme for phase noise reduction is a feed-forward technique where the laser phase noise is measured and subtracted from the phase of the laser in a feed-forward configuration. See M. Bagheri, F. Aflatouni, A. Imani, A. Goel, and H. Hashemi, “Semiconductor laser phase noise cancellation using an electrical feed-forward scheme,” Opt. Lett., vol. 34, no. 19, pp. 2979-2981, Oct. 1, 2009; R. D. Esman and K. Iwashita, “High-frequency optical FM noise reduction employing a fiber-insertable feed-forward technique,” in Dig. Conf. Optical Fiber Commun., vol. 5, OSA Tech. Dig. Series (Optical Society of America, 1992), paper TuM3; and O. Solgaard, J. Park, J. B. Georges, P. K. Pepeljugoski, and K. Y. Lau, “Millimeter wave, multigigahertz optical modulation by feedforward phase noise compensation of a beat note generated by photomixing of two laser diodes,” IEEE Photon. Technol. Lett., vol. 5, no. 5, pp. 574-577, 1993. No feedback may be involved in the feed-forward system. Thus, instability may not be a concern.

In principle, feed-forward phase noise reduction is capable of canceling the laser phase noise over a large bandwidth. Unlike a feedback approach, the feed-forward method may be independent of the laser source characteristics, as it is may be applied on the output light of the source.

The ultimate achieved line-width in a feed-forward phase noise reduction scheme is limited to the amplitude and phase mismatches between the signals in the discrimination and cancellation paths, and the noise generated in the phase-frequency discrimination and electrical circuitries.

### SUMMARY

A laser phase noise reduction system may reduce phase noise in a laser field generated by a laser.

In one configuration, a phase-frequency discriminator may be configured to receive a first portion of the laser field and to generate an electrical output that includes information about the phase or frequency of the laser field. An electrical filter may be configured to receive the electrical output of the phase-frequency discriminator and to generate an electrical signal that represents the electrical output of the phase-frequency discriminator filtered by filtering criteria. A phase modulator may be configured to receive a second portion of the laser field different from the first portion of the laser field and to modulate the second portion of the laser field with the electrical signal from the electrical filter, thereby reducing phase noise in the second portion of the laser field.

The phase-frequency discriminator may be resonator-based. The resonator-based phase-frequency discriminator may include a resonator coupled to a waveguide.

In another configuration, a frequency discriminator may be configured to receive a first portion of the laser field and to generate an electrical output that includes information about the frequency of the laser field. A voltage or current controlled oscillator (VCO or CCO) may be configured to receive the electrical output of the frequency discriminator and to generate an oscillation that has a frequency that is a function of the electrical output of the frequency discriminator. An amplitude modulator may be configured to receive the oscillation from the voltage or current controlled oscillator and to modulate the amplitude of a second portion of the laser field with the oscillation from the oscillator, thereby reducing phase noise in the second portion of the laser field.

The amplitude modulator may be a quadrature or single sideband amplitude modulator.

The frequency discriminator may be a delay-line discriminator.

A first laser phase noise reduction system may be configured to reduce a first portion of the phase noise, and a second laser phase noise reduction system may be configured to reduce a second portion of the phase noise that is different from the first portion after the reduction of the first portion of the phase noise by the first laser phase noise reduction system.

The laser phase noise reduction system may be configured to receive laser fields generated by a tunable laser that have a range of different wavelengths and to reduce phase noise in all of those laser fields across the range of the different wavelengths.

The laser phase noise reduction system may include both a feed-forward and a feedback laser phase noise reduction system, both configured to reduce the phase noise in the laser field.

The feed-forward and the feedback laser phase noise reduction systems may each have an input configured to receive at least a portion of the same laser field.

The feed-forward laser phase noise reduction system may produce an output laser field with reduced phase noise, and the feedback laser phase noise reduction system may have an input configured to the output from the feed-forward laser phase noise reduction system.

The feed-forward and the feedback laser phase noise reduction systems may share a common phase discriminator.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1A illustrates an example of output from an ideal laser.

FIG. 1B illustrates an example of output from a real semiconductor laser.

FIG. 2 illustrates an example of a semiconductor laser and an associated feed-forward phase noise reduction system.

FIG. 3 illustrates an example of a feed-forward phase noise reduction system that utilizes a phase discriminator and a phase modulator.

FIG. 4 illustrates an example of a feed-forward phase noise reduction system that utilizes a frequency discriminator, integrator, and phase modulator.

FIG. 5 illustrates an example of a feed-forward phase noise reduction system that utilizes a phase discriminator, a filter, and a phase modulator.

FIG. 6 illustrates an example of a feed-forward phase noise reduction system that utilizes a phase-frequency discriminator, a filter, and a phase modulator.

FIG. 7 illustrates an example of a feed-forward phase noise reduction system that utilizes a frequency discriminator, a voltage or current controlled oscillator, and an amplitude modulator.

FIG. 8 illustrates an example of a feed-forward phase noise reduction system that utilizes a frequency discriminator, a voltage or current controlled oscillator, and a quadratuer or single-sideband amplitude modulator.

FIG. 9 illustrates an example of a feed-forward phase noise reduction system that utilizes a resonator-based phase-frequency discriminator, a filter, and a phase modulator.

FIG. 10 illustrates an example of a sequential series of feed-forward phase noise reduction systems, each of which may reduce a different portion of phase noise.

FIG. 11 illustrates an example of a feed-forward phase noise reduction system that utilizes a delay line frequency discriminator, an integrator, and a phase modulator.

FIG. 12 illustrates an example of a feed-forward phase noise reduction system that utilizes a delay line frequency discriminator, a voltage or current controlled oscillator, and an amplitude modulator.

FIG. 13 illustrates an example of a feed-forward phase noise reduction system that utilizes a delay line frequency discriminator, a voltage or current controlled oscillator, and a quadrature or single side band amplitude modulator.

FIG. 14 illustrates an example of a feed-forward phase noise reduction system that utilizes a resonator-based phase-frequency discriminator, a filter, and a phase modulator.

FIG. 15 illustrates an example of a feed-forward phase noise reduction system that is suitable for a tunable semiconductor laser.

FIG. 16 illustrates a tunable semiconductor laser that includes a feed-forward phase noise reduction system within its housing.

FIG. 17A illustrates a feed-forward phase noise reduction system that is used in conjunction with a feedback phase noise reduction system and that both receive as an input a portion of the light field output from a semiconductor laser.

FIG. 17B illustrates a feed-forward phase noise reduction system that is used in conjunction with a feedback phase noise reduction system that receives as its input the output from the feed-forward phase noise reduction system.

FIG. 18 illustrates a feed-forward phase noise reduction system that is used in conjunction with a feedback phase noise reduction system that share a common phase discriminator.

FIG. 19 illustrates an example of a feed-forward phase noise reduction system.

FIG. 20A illustrates an MZI block diagram as a frequency detector; FIG. 20B illustrates a phase adjustment loop; and FIG. 20C illustrates an equivalent model of the phase adjustment loop.

FIG. 21 illustrates phase adjustment loop performance for an open loop, a closed loop, and when locking to quadrature point.

FIG. 22 is an FFLR scheme block diagram.

FIG. 23 shows the measured power spectrum of photodiode current at the output of an MZI with a delay of about 3 ns.

FIG. 24 illustrates a simulated linewidth reduction of a laser using an FFLR scheme in the presence of 30% gain mismatch between the feed-forward arm and the main arm in FIG. 22.

FIG. 25 illustrates a top-bench feed-forward phase noise cancellation system for the proposed FFLR scheme.

FIG. 26 illustrates measured discriminated frequency noise with and without applying the feed-forward signal in FIG. 25.

FIG. 27 illustrates a measured self-heterodyne spectrum with and without applying the feed-forward signal in FIG. 25.

FIGS. 28A and 28B illustrate a mismatch between the measured laser noise in phase and the original laser noise in phase. FIG. 28A illustrates only delay mismatch; FIG. 28B illustrates gain and delay mismatches.

FIG. 29 illustrates a measured effect of a delay mismatch between the main and feed-forward arms in FIG. 25.

FIG. 30 illustrates a measured effect of the gain mismatch between the main and feed-forward arms in FIG. 25.

FIG. 31 illustrates a measured and simulated effect of off-quadrature locking of MZI on FM noise cancellation.

FIG. 32A illustrates two sources of non-idealities, namely, a non-ideal integrator modeled as an ideal integrator in series with a high pass filter, and an amplitude and delay mismatch between the discrimination and cancellation paths.

FIG. 32B illustrates a simplified model for a system with these non-idealities.

FIG. 33 illustrates a measured and simulated effect of integrator corner frequency on linewidth reduction (with a laser biased at 40 mA).

FIG. 34 illustrates cascading OPMs to improve linewidth reduction.

FIGS. 35A and 35B illustrate phase noise cancellation improvement when a single OPM is replaced by two cascaded OPMs. FIG. 35A illustrates a measured frequency noise comparison; FIG. 35B illustrates a measured linewidth reduction comparison.

FIG. 36 illustrates the effect of electronic circuitry noise on FFLR scheme performance.

FIGS. 37A and 37B illustrate the RIN effect in frequency noise discrimination. FIG. 37A illustrates single photo-diode detection, and FIG. 37B illustrates balanced photodiode detection.

FIGS. 38A and 38B illustrate the effect of the balanced photodiode on frequency noise reduction (FIG. 38A) and linewidth reduction (FIG. 38B).

FIG. 39 illustrates measured linewidth reduction when both balanced photodiodes and cascaded OPMs are used in FFLR scheme.

FIG. 40 illustrates top-bench feed-forward phase noise cancellation scheme with balanced detection and cascaded OPMs.

FIG. 41 is a diagram of a phase noise cancellation system in which laser output is split into two branches.

FIG. 42A illustrates an SSB modulation concept; FIG. 42B illustrates an electro-optical SSB modulator block diagram; and FIG. 42C is a graphical representation of SSB action.

FIG. 43A illustrates a benchtop phase noise cancellation system; FIG. 43B illustrates measured heterodyne spectrum of the laser before and after phase noise cancellation and its zoomed-in version (the inset); FIG. 43C illustrates the measured and calculated effect of the MZI delay on the minimum achievable linewidth (the calculation is based on 37 pA/\sqrt{Hz} input referred current noise of electronic circuitry dominating the photodiode shot noise and the laser intensity noise after balanced detection); and FIG. 43D illustrates the measured highly tunable linewidth reduction capability of the proposed phase noise cancellation system.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

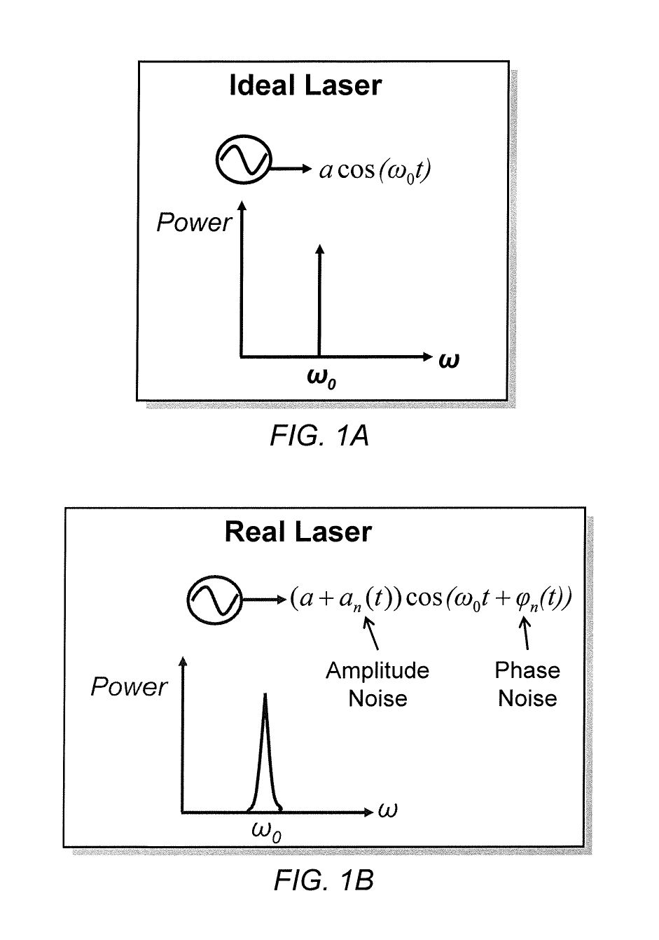

FIG. 1A illustrates an example of output from an ideal laser. As illustrated in FIG. 1A, the output of the ideal laser may be a laser field that may be noise free and that may consist of only a sign wave signal at a constant frequency.

FIG. 1B illustrates an example of output from a real semiconductor laser. As illustrated in FIG. 1B, the output from a real semiconductor laser may have both amplitude and phase noise.

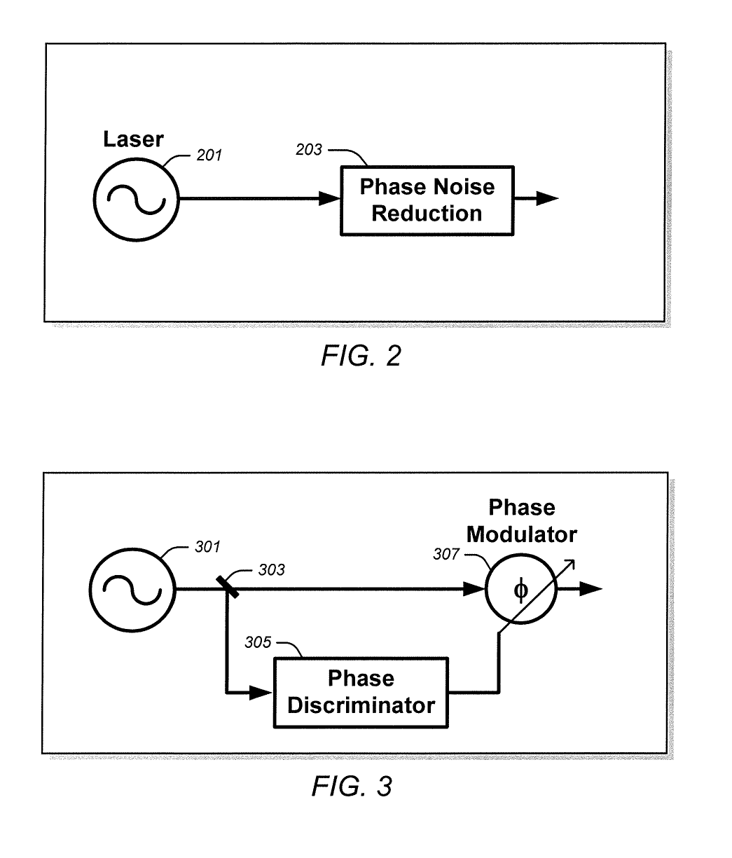

FIG. 2 illustrates an example of a semiconductor laser 201 and an associated feed-forward phase noise reduction system 203. The feed-forward phase noise reduction system 203 may be configured to reduce phase noise in a laser field generated by the semiconductor laser 201. Various examples of phase noise reductions systems are now presented.

FIG. 3 illustrates an example of a feed-forward phase noise reduction system that utilizes a phase discriminator 305 and a phase modulator 307. A semiconductor laser 301 may have its laser field output split by a splitter 301, so that a portion of the output is delivered to the phase discriminator 305 and another portion is delivered to the phase modulator 307. The phase discriminator 305 may be configured to produce information about the phase of the laser field. The phase modulator 307 may be configured to optically modulate its portion of the laser field with the output from the phase discriminator 305, thereby reducing phase noise in the laser field.

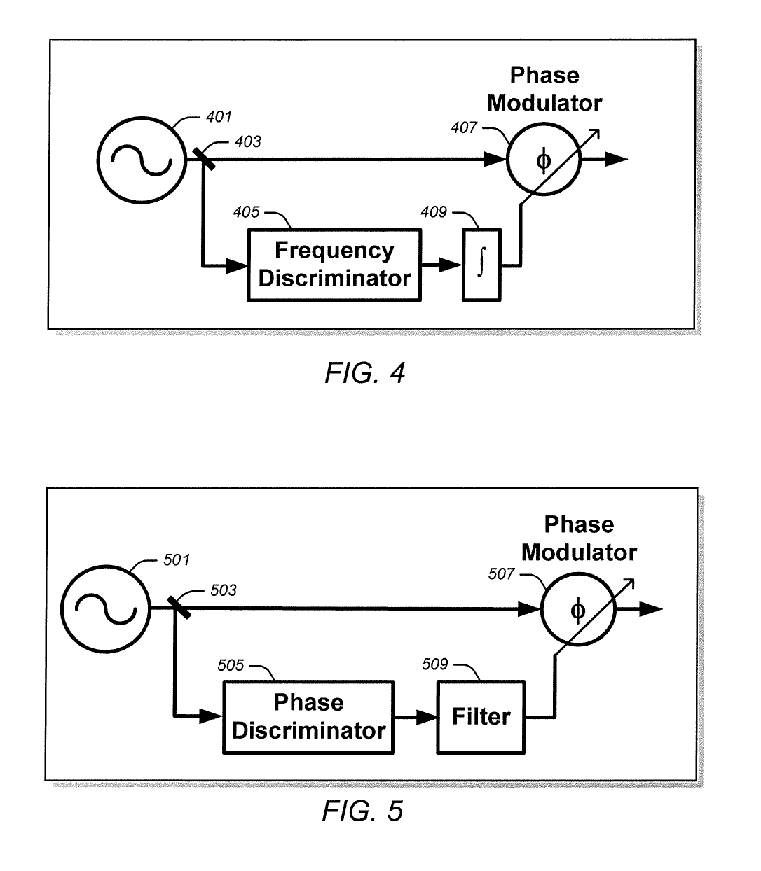

FIG. 4 illustrates an example of a feed-forward phase noise reduction system that utilizes a frequency discriminator 405, an integrator 409, and a phase modulator 407. A semiconductor laser 401 may have its laser field output split by a splitter 403, so that a portion of the output is delivered to the frequency discriminator 405 and another portion is delivered to the phase modulator 407. The frequency discriminator 405 may be configured to produce information about the frequency of the laser field. This output may be integrated by the integrator 409, thereby producing an oscillation. The phase modulator 307 may be configured to optically modulate its portion of the laser field with the output from the integrator 409, thereby reducing frequency noise in the laser field.

FIG. 5 illustrates an example of a feed-forward phase noise reduction system that utilizes a phase discriminator 505, a filter 509, and a phase modulator 507. A semiconductor laser 501 may have its laser field output split by a splitter 503, so that a portion of the output is delivered to the phase discriminator 505 and another portion is delivered to the phase modulator 507. The phase discriminator 505 may be configured to produce information about the phase of the laser field. This output may be filtered by a filter 509 to shape the phase noise reduction profile. The filter, for instance, can compensate for the non-ideal frequency-dependent response of the phase discriminator. The phase modulator 507 may be configured to optically modulate its portion of the laser field with the output from the filter 509, thereby reducing phase noise in the laser field.

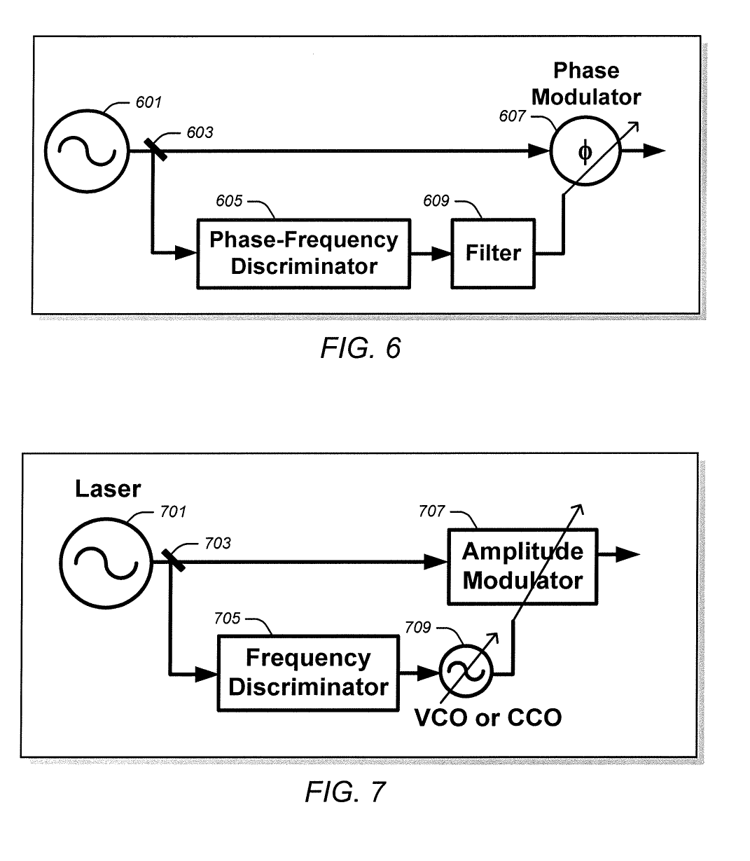

FIG. 6 illustrates an example of a feed-forward phase noise reduction system that utilizes a phase-frequency discriminator 605, a filter 609, and a phase modulator 607. A semiconductor laser 601 may have its laser field output split by a splitter 603, so that a portion of the output is delivered to the phase-frequency discriminator 605 and another portion is delivered to the phase modulator 607. The phase-frequency discriminator 605 may be configured to produce information about the phase and/or frequency of the laser field. This output may be filtered by a filter 609 to shape the phase-frequency noise reduction profile. The filter, for instance, can compensate for the non-ideal frequency-dependent response of the frequency-phase discriminator. The phase modulator 607 may be configured to optically modulate its portion of the laser field with the output from the filter 609, thereby reducing phase noise in the laser field.

FIG. 7 illustrates an example of a feed-forward phase noise reduction system that utilizes a frequency discriminator 705, a voltage or current controlled oscillator 709, and an amplitude modulator 707. A semiconductor laser 601 may have its laser field output split by a splitter 703, so that a portion of the output is delivered to the frequency discriminator 705 and another portion is delivered to the amplitude modulator 707. The frequency discriminator 705 may be configured to produce information about the frequency of the laser field. This output may be delivered to the voltage or current controlled oscillator (VCO or CCO) 709 that generates an oscillation that has a frequency that is a function of the output of the frequency discriminator 705. The amplitude modulator 707 may be configured to optically modulate its portion of the laser field with the output from the VCO or CCO 709, thereby reducing phase noise in the laser field.

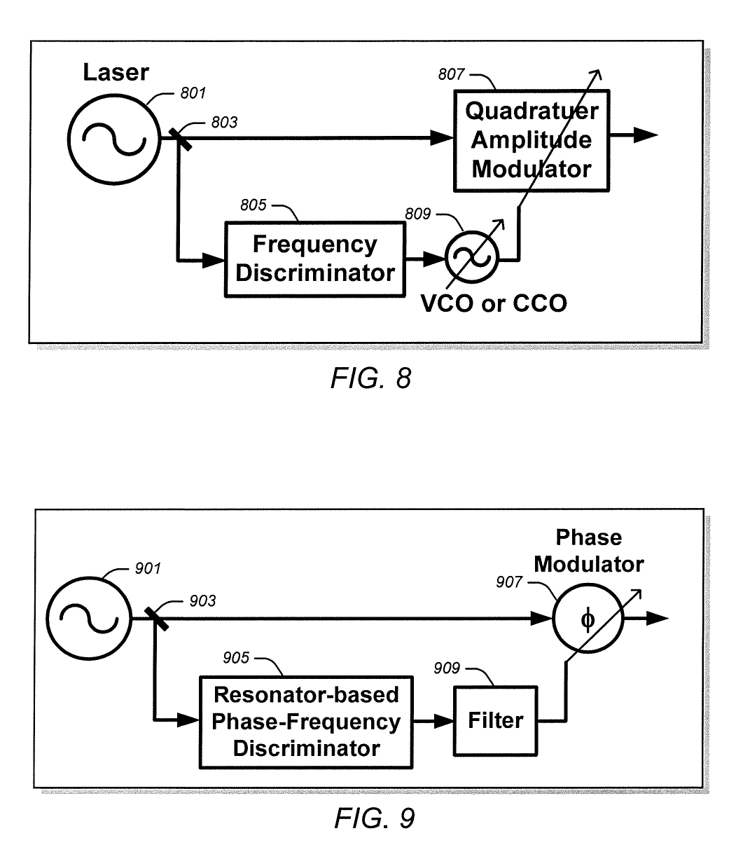

FIG. 8 illustrates an example of a feed-forward phase noise reduction system that utilizes a frequency discriminator 805, a voltage or current controlled oscillator 809, and a quadratuer or single-sideband amplitude modulator 807. A semiconductor laser 801 may have its laser field output split by a splitter 803, so that a portion of the output is delivered to the frequency discriminator 805 and another portion is delivered to the quadratuer or single-sideband amplitude modulator 807. The frequency discriminator 805 may be configured to produce information about the frequency of the laser field. This output may be delivered to the voltage or current controlled oscillator (VCO or CCO) 809 that generates an oscillation that has a frequency that is a function of the output of the frequency discriminator 805. The quadratuer or single-sideband amplitude modulator 807 may be configured to optically modulate its portion of the laser field with the output from the VCO or CCO 809, thereby reducing phase noise in the laser field.

FIG. 9 illustrates an example of a feed-forward phase noise reduction system that utilizes a resonator-based phase-frequency discriminator 905, a filter 909, and a phase modulator 907. A semiconductor laser 901 may have its laser field output split by a splitter 903, so that a portion of the output is delivered to the resonator-based phase-frequency discriminator 905 and another portion is delivered to the phase modulator 907. The resonator-based phase-frequency discriminator 905 may be configured to produce information about the phase and/or frequency of the laser field. This output may be filtered by the filter 909 to shape the phase noise reduction profile. The filter, for instance, can compensate for the non-ideal frequency-dependent response of the discriminator. The phase modulator 907 may be configured to optically modulate its portion of the laser field with the output from the filter 909, thereby reducing phase noise in the laser field.

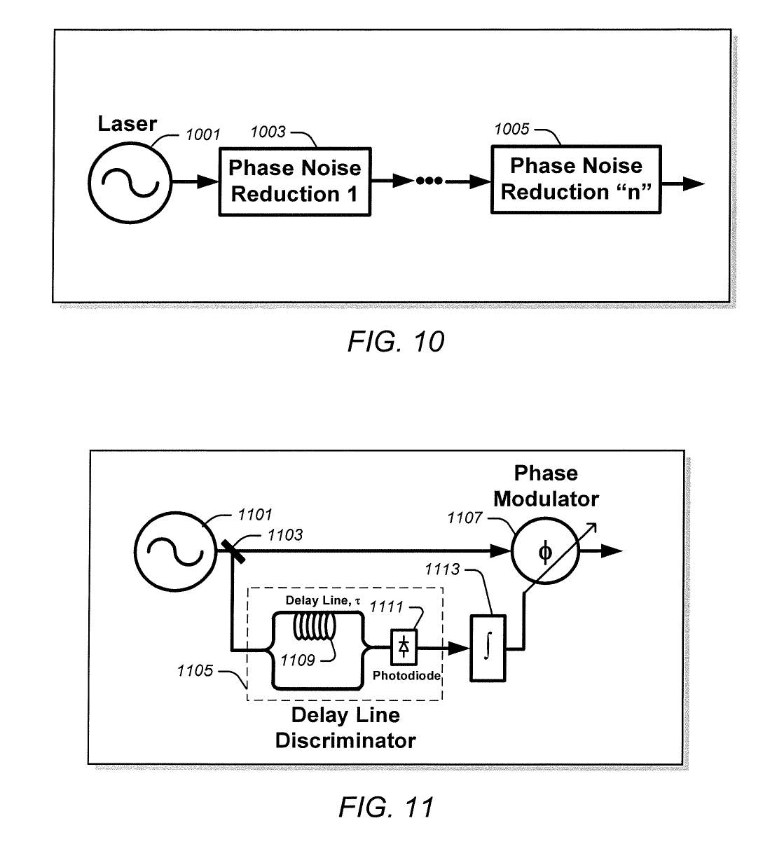

FIG. 10 illustrates an example of a sequential series of feed-forward phase noise reduction systems 1003 and 1005, each of which may reduce a different portion of phase noise in the laser field output from the semiconductor laser 1001. The feed-forward phase noise reduction make thus occur in multiple steps. Each feed-forward phase noise reduction system may be any of the types discussed herein.

FIG. 11 illustrates an example of a feed-forward phase noise reduction system that utilizes a delay line frequency discriminator 1105, an integrator 1113, and a phase modulator 1107. A semiconductor laser 1101 may have its laser field output split by a splitter 1103, so that a portion of the output is delivered to the delay line frequency discriminator 1105 and another portion is delivered to the phase modulator 1107. The delay line frequency discriminator 1105 may include a delay line 1109 and a photodiode 1111 and may be configured to produce information about the frequency of the laser field. This output may be delivered to the integrator 1113. The phase modulator 1107 may be configured to optically modulate its portion of the laser field with the output from the integrator 1113, thereby reducing phase noise in the laser field.

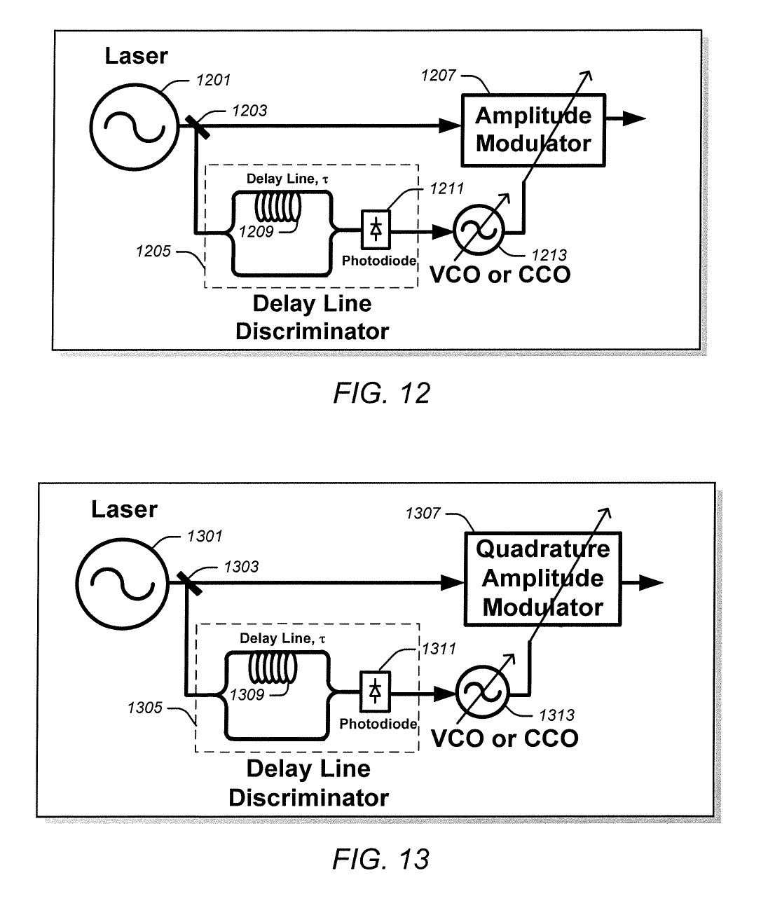

FIG. 12 illustrates an example of a feed-forward phase noise reduction system that utilizes a delay line frequency discriminator 1205, a voltage or current controlled oscillator 1213, and an amplitude modulator 1207. A semiconductor laser 1201 may have its laser field output split by a splitter 1203, so that a portion of the output is delivered to the delay line frequency discriminator 1205 and another portion is delivered to the amplitude modulator 1207. The delay line frequency discriminator 1205 may include a delay line 1209 and a photodiode 1211 and may be configured to produce information about the frequency of the laser field. This output may be delivered to the voltage or current controlled oscillator (VCO or CCO) 1213. The amplitude modulator 1207 may be configured to optically modulate its portion of the laser field with the output from the voltage or current controlled oscillator (VCO or CCO) 1213, thereby reducing phase noise in the laser field.

FIG. 13 illustrates an example of a feed-forward phase noise reduction system that utilizes a delay line frequency discriminator 1305, a voltage or current controlled oscillator 1313, and a quadrature or single side band amplitude modulator 1307. A semiconductor laser 1301 may have its laser field output split by a splitter 1303, so that a portion of the output is delivered to the delay line frequency discriminator 1305 and another portion is delivered to the quadrature or single side band amplitude modulator 1307. The delay line frequency discriminator 1305 may include a delay line 1309 and a photodiode 1311 and may be configured to produce information about the frequency of the laser field. This output may be delivered to the voltage or current controlled oscillator (VCO or CCO) 1313. The quadrature or single side band quadrature amplitude modulator 1307 may be configured to optically modulate its portion of the laser field with the output from the voltage or current controlled oscillator (VCO or CCO) 1313, thereby reducing phase noise in the laser field.

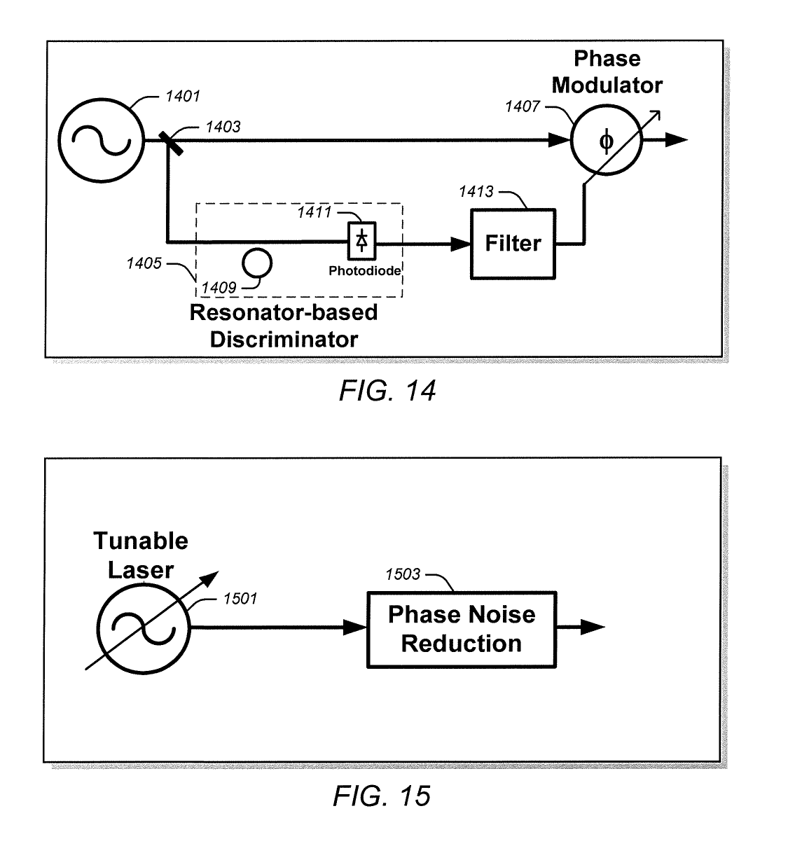

FIG. 14 illustrates an example of a feed-forward phase noise reduction system that utilizes a resonator-based phase-frequency discriminator 1405, a filter 1413, and a phase modulator 1407. A semiconductor laser 1401 may have its laser field output split by a splitter 1403, so that a portion of the output is delivered to the resonator-based phase-frequency discriminator 1405 and another portion is delivered to the phase modulator 1407. The resonator-based phase-frequency discriminator 1405 may include a resonator 1409 coupled to a waveguide (shown by the straight line above the resonator 1409), and a photodiode 1411, and may be configured to produce information about the phase and/or frequency of the laser field. This output may be filtered by the filter 1413 to shape the phase noise reduction profile. The filter, for instance, can compensate for the non-ideal frequency-dependent response of the discriminator. The phase modulator 1407 may be configured to optically modulate its portion of the laser field with the output from the filter 1413, thereby reducing phase noise in the laser field.

FIG. 15 illustrates an example of a feed-forward phase noise reduction system 1503 that is suitable for a tunable semiconductor laser 1501. The tunable semiconductor laser 1501 may be configured to generate laser fields that have a range of different wavelengths. The feed-forward phase noise reduction system 1503 may be configured to reduce phase noise in all of these laser fields across the range of the different wavelengths. The feed-forward phase noise reduction system 1503 may be any of the types discussed herein. The tunable semiconductor laser 1501 and the feed-forward phase noise reduction system 1503 may be in separate packages.

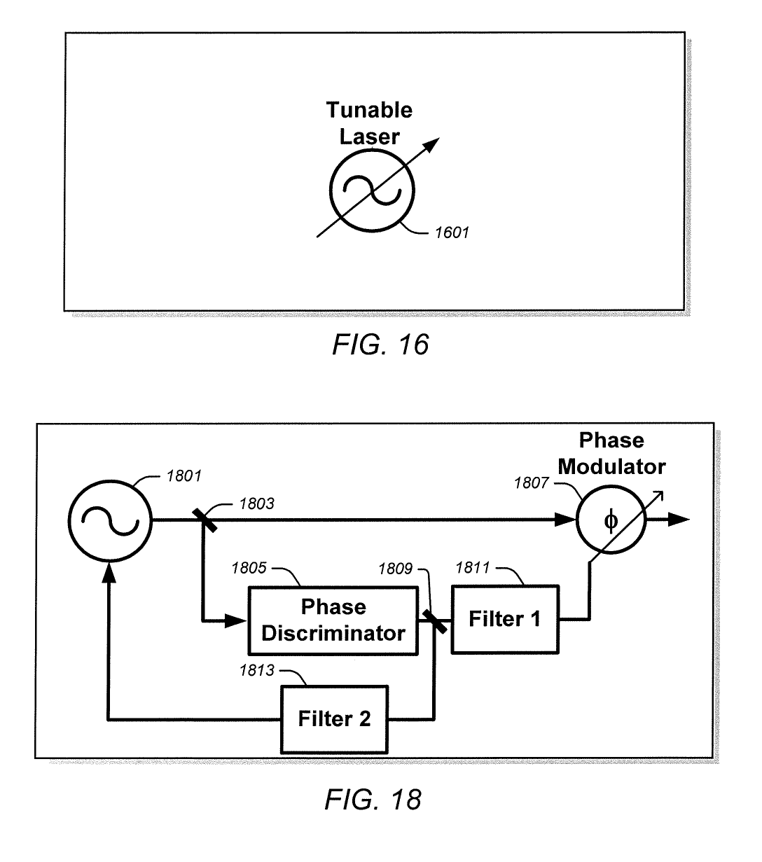

FIG. 16 illustrates a tunable semiconductor laser 1601 that includes a feed-forward phase noise reduction system within its housing. The feed-forward phase noise reduction system may be any the types described herein.

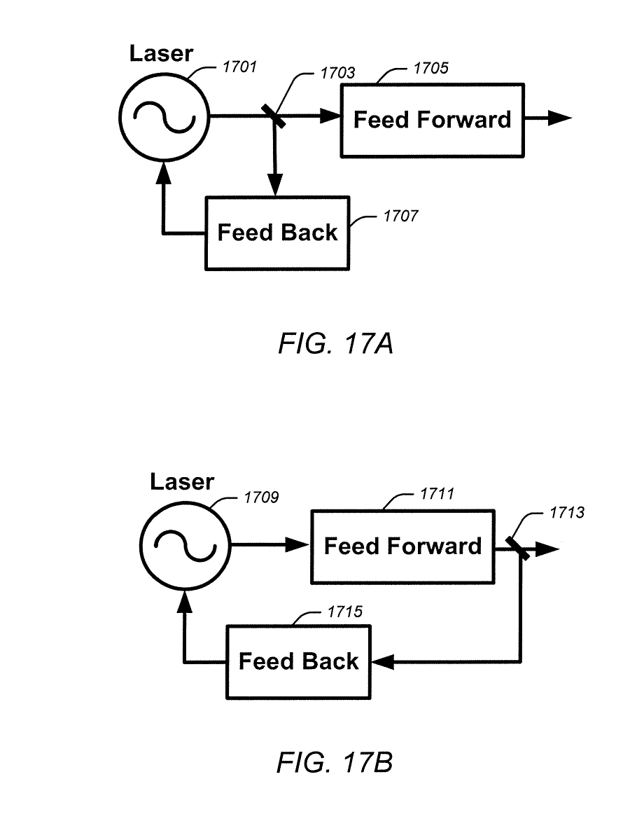

FIG. 17A illustrates a feed-forward phase noise reduction system 1705 that is used in conjunction with a feedback phase noise reduction system 1707 and that both receive as an input a portion of the light field output from a semiconductor laser 1701. The semiconductor laser 1701 may have its laser field output split by a splitter 1703, so that a portion of the output is delivered to the feed-forward phase noise reduction system 1705 and another portion is delivered to the feedback phase noise reduction system 1707. The output of the feedback phase noise reduction system 1707 may be delivered back to the semiconductor laser 1701. The semiconductor laser 1701 may be configured to adjust its laser field output based on this output, thereby reducing phase noise in its laser field output. The feed-forward and feedback phase noise reduction systems 1705 and 1707 may each be configured to reduce the phase noise in the laser field. The feed-forward phase noise reduction system 1705 may be any of the types discussed herein.

FIG. 17B illustrates a feed-forward phase noise reduction system 1711 that is used in conjunction with a feedback phase noise reduction system 1715 that receives as its input the output from the feed-forward phase noise reduction system 1715. A semiconductor laser 1709 may have its laser field output delivered to the feed-forward phase noise reduction system 1711. The output of the feed-forward phase noise reduction system 1711 may be delivered to a splitter 1713, so that a portion of its output may be used for a useful purpose and another portion is delivered to the feedback phase noise reduction system 1715. The output of the feedback phase noise reduction system 1715 may be delivered back to the semiconductor laser 1709. The semiconductor laser 1709 may be configured to adjust its laser field output based on this output, thereby reducing phase noise in its laser field output. The feed-forward and feedback phase noise reduction systems 1711 and 1715 may each be configured to reduce the phase noise in the laser field. The feed-forward phase noise reduction system 1711 may be any of the types discussed herein.

FIG. 18 illustrates a feed-forward phase noise reduction system that is used in conjunction with a feedback phase noise reduction system that share a common phase discriminator 1805. A semiconductor laser 1801 may have its laser field output split by a splitter 1803, so that a portion of the output is delivered to the phase discriminator 1805 and another portion is delivered to a phase modulator 1807. The output of the phase discriminator 1805 may be delivered to a splitter 1809, so that a portion of its output is delivered to a filter 1811 and another portion is delivered to a filter 1813. The output of the filter 1813 may be delivered back to the semiconductor laser 1801, and the output of the filter 1811 may be delivered to the phase modulator 1807. The semiconductor laser 1801 may be configured to adjust its laser field output based on the output from the filter 1813, thereby reducing phase noise in its laser field output. The phase modulator 1807 may be configured to optically modulate its portion of the laser field with the output from the filter 1811, thereby reducing phase noise in the laser field. The filter 1813 may be configured to assist with the stability of the feedback loop, or compensate for the non-ideal frequency-dependent response of the discriminator. Similarly, the filter 1811 may be configured to, for instance, compensate for the non-ideal frequency-dependent response of the discriminator, or create a complementary response to that created in the feed-back loop, to extend the frequency range of the overall phase noise cancellation scheme.

Any or all of the optical or electrical components in the feed-forward noise reduction systems that have been discussed may be implemented using silicon devices, such as semiconductor devices, such as common and/or compound semiconductor devices.

Examples and other details about some of these types of these noise reduction systems are now presented.

### Feed-Forward Phase Noise Cancellation

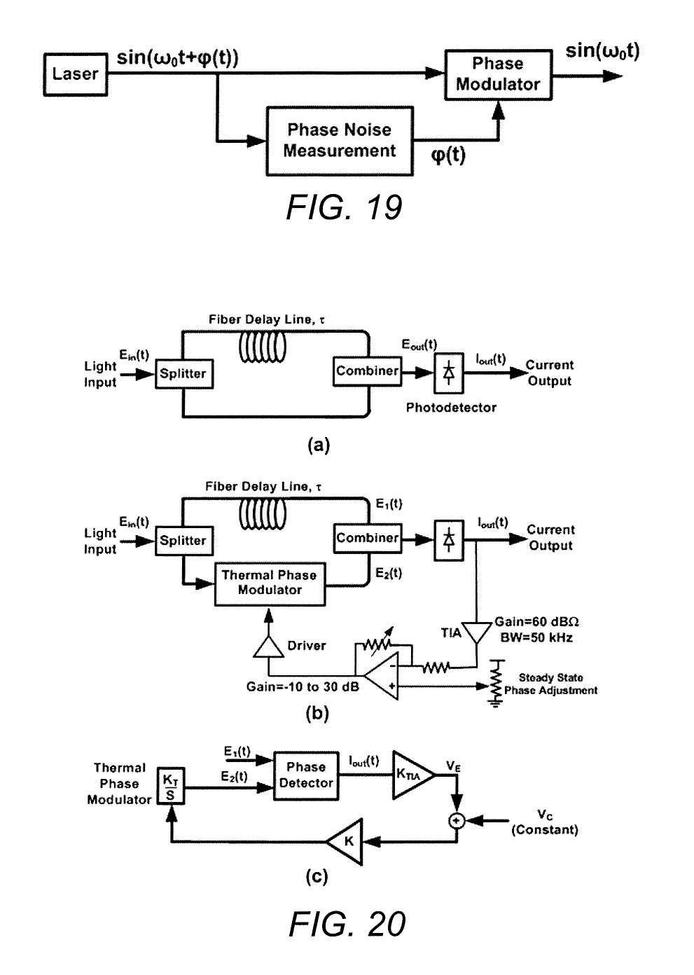

FIG. 19 illustrates an example of a feed-forward phase noise cancellation system. Noise in phase may first be detected using a phase discriminator block, and then subtracted from the phase of the signal in a feed-forward manner.

There are different ways of discriminating laser phase noise, such as Mach-Zehnder interferometer (MZI), multiple-beam interferometers [e.g., fiber Bragg gratings (FBGs)], and Fabry-Pérot (FP) resonators. MZI is now used herein as an example to discriminate the signal phase.

FIG. 20A illustrates an MZI block diagram as a frequency detector; FIG. 20B illustrates a phase adjustment loop; and FIG. 20C illustrates an equivalent model of the phase adjustment loop.

In FIG. 20A, the input light is split into two branches. The top branch is delayed by and recombined with the bottom branch. The light at the output of the optical combiner is converted to electrical current using a photodetector. Assuming the input light to have the form of Eᵢₙ(t)=A cos(ω₀t+φ(t)), the AC component of the output current can be written as

i_{out,ac}=R\sqrt{P₁P₂} cos [ω₀τ+φ(t)−φ(t−τ)] (1)

where R, P₁, and P₂ are the photodiode responsivity, and the optical power in the top and bottom branches, respectively. Also, it is assumed that the light polarization does not change throughout the MZI. In the top-bench implementation of the system, the relative phase between two arms of MZI varies slowly due to environmental fluctuations. This slow, but large, fluctuation is mainly due to the fact that both fiber index of refraction and length are temperature dependent.

A first-order feedback loop is used to suppress the slow fluctuations as shown in FIG. 20B. A thermal phase modulator (TPM) is added to the lower branch of the MZI to compensate for the relative phase fluctuations. TPM is a piece of optical fiber coated with thin film of silver (S. J. Rogers, J. B. Brown, J. D. C. Jones, R. K. Y. Chan, and H. H. Wong, “Single chip interferometer thermal phase-quadrature con-troller,” Meas. Sci. Technol., no. 7, pp. 209-211, 1996). Injecting current to the silver coating, changes the fiber temperature and modulates the phase of the light traveling in the optical fiber. Since the phase of the light traveling in the TPM increases almost linearly for a DC injected current, the TPM can be approximately modeled as an integrator. FIG. 20C depicts the equivalent first-order type-I control loop that compensates the thermal phase fluctuations between two arms of MZI. The steady-state relative phase between two arms of MZI can be written as

$${Δφ}_{ss} = {cos}^{- 1} ( - \frac{{RK}_{TIA} ( {P}_{1} + {P}_{2} ) + 2 {V}_{2}}{2 {RK}_{TIA} \sqrt{{P}_{1} {P}_{2}}} ) \qquad ( 2 )$$

where Δφ_{gg}, K_{TIA}, and V_{c} are the steady-state phase difference between two MZI arms, the gain of the transimpedance amplifier (TIA), and a control voltage, respectively.

Based on (2), the steady-state phase difference between two arms of MZI can be adjusted by changing the value of control voltage V_{c}. As is discussed below, it may be desirable to set the two arms of the MZI to be in quadrature. This corresponds to the point with the maximum phase to intensity conversion gain.

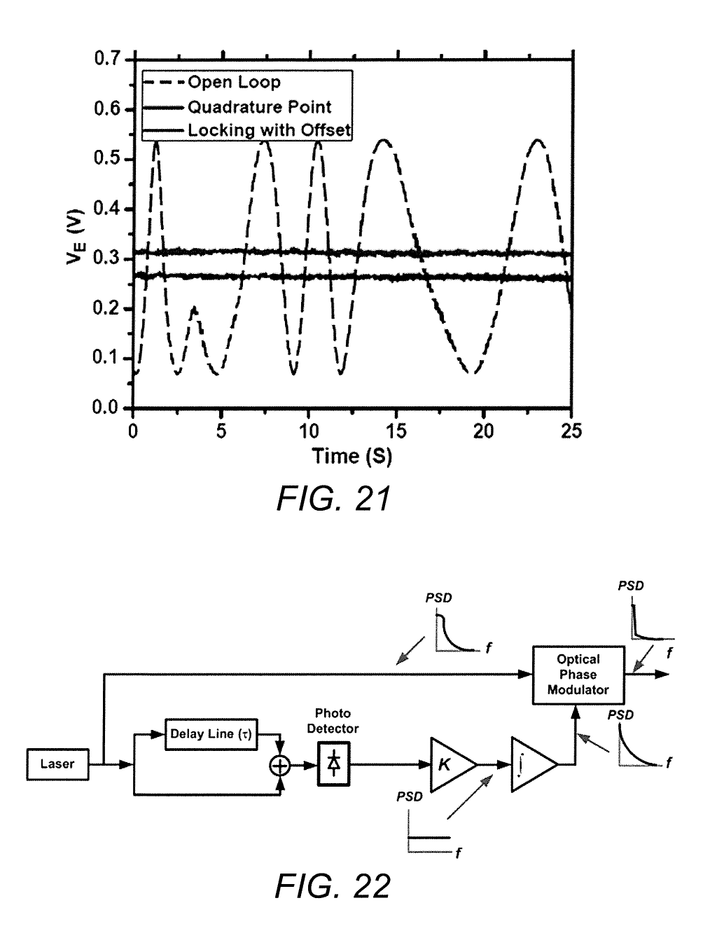

FIG. 21 illustrates a phase adjustment loop performance for open loop, closed loop, and locking to quadrature point. FIG. 21 shows the performance of the phase adjustment loop where offset locking and locking at the quadrature point are depicted. The voltage V_{E} after the TIA in FIG. 20C corresponds to the open-loop slow relative phase fluctuation between two arms of MZI. The peak-to-peak voltage variation of V_{E} corresponds to 360° relative phase variation. When the loop is closed, these variations are suppressed by an amount equal to the loop gain. The ratio of the peak-to-peak of in locked and unlocked conditions (in FIG. 22) indicates that the phase adjustment loop reduces the relative phase fluctuations to less than 8°.

Using the constant V_{c} the MZI can be locked at the quadrature point. In this case, ω₀τ=π/2 and (1) is simplified to

i_{out,ac}=R\sqrt{P₁P₂} sin [φ(t)−φ(t−τ)] (3)

In the case where the laser noise in phase φ(t) is a Gaussian random walk, φ(t) is a mean-zero Weiner process with a variance increasing linearly with time (i.e., φ(t)˜N(0, Ct)), and the power spectral density (PSD) of the laser output has a Lorentzian profile with a −3-dB linewidth of C. In this case, since the process φ(t)−φ(t−τ) is bounded and small, (3) can be written in the form

i_{out,ac}≈R\sqrt{P₁P₂}τd/dtφ(t) (4)

Equation (4) indicates that the MZI detects the frequency noise of the laser.

FIG. 22 is an FFLR scheme block diagram. As shown in FIG. 22, to obtain the noise in phase, it may be required to amplify (by gain of 1/(Rτ\sqrt{P₁P₂})) and integrate the photodiode current. Once the noise in phase is measured, it can be subtracted from the noise in phase of the laser (e.g., using an optical phase modulator) to reduce its linewidth.

Under the Gaussian random walk assumption for the laser noise in phase, the power spectral density of the AC component of the photodiode current can be written as [see the Appendix below]

$${S}_{i , PD} ( ω ) = \frac{{R}^{2} {P}_{1} {P}_{2} {e}^{- {C}_{τ}} C}{{C}^{2} + {ω}^{2}} [ [ cosh ( {C}_{τ} ) - cos ( ωτ ) ] \times {sin}^{2} ( {ω}_{0} τ ) + {cos}^{2} ( {ω}_{0} τ ) [ sinh ( C τ ) - C \frac{sin ( ωτ )}{ω} ] ] \qquad ( 5 )$$

where ω₀ is the laser frequency. For an MZI locked at the quadrature point, (5) is simplified to

$${S}_{i , PD} ( ω ) = \frac{{R}^{2} {P}_{1} {P}_{2} {e}^{- {C}_{τ}} C}{{C}^{2} + {ω}^{2}} [ cosh ( {C}_{τ} ) - cos ( ωτ ) ] . \qquad ( 6 )$$

If the delay in the MZI is set to be much smaller than the laser coherence time (i.e. τ<<(1/C)), and for ω>>C, (6) is simplified to

$${S}_{i , PD} ( ω ) \approx \frac{{R}^{2} {P}_{1} {P}_{2} C}{{C}^{2} + {ω}^{2}} 2 {sin}^{2} ( \frac{ωτ}{2} ) \qquad ( 7 )$$

Which indicates that S_{i,PD}(ω) has periodic zeros at f=(k/τ), (kε [symbol] ). Also for low frequencies where f<<(1/τ), from (6), the power spectral density of the photodiode current is frequency independent and is approximately equal to (1/2)R²P₁P₂Cτ².

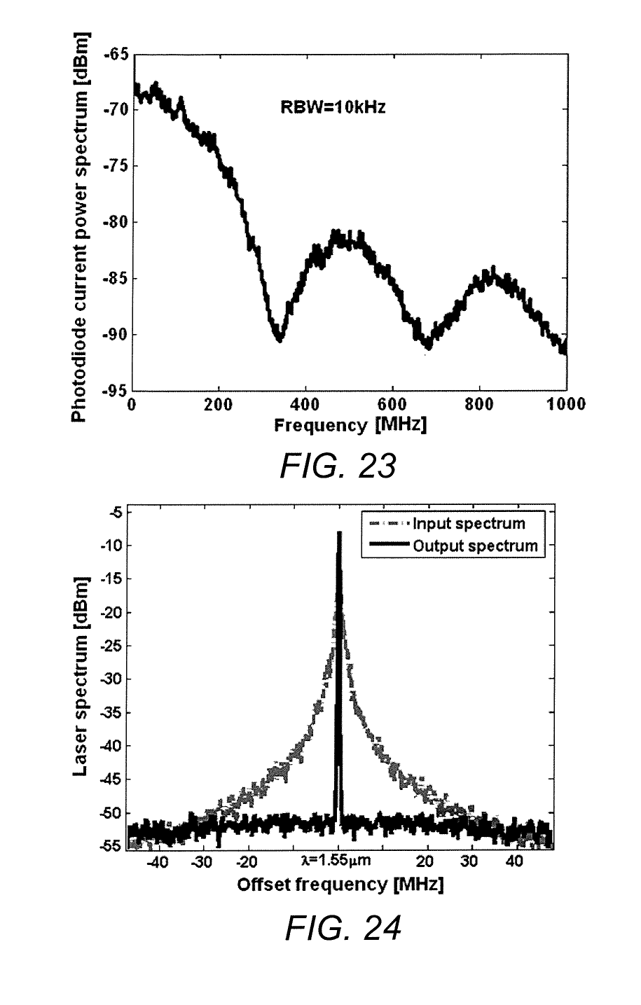

FIG. 23 shows the measured power spectrum of the photodiode current as the output of an MZI. The 330-MHz null spacing corresponds to a 3-ns delay difference between two arms of the MZI.

FIG. 24 illustrates a simulated linewidth reduction of a laser using FFLR scheme in presence of 30% gain mismatch between the feed-forward arm and the main arm in FIG. 22. Laser average power entering the MZI, photodiode responsivity, the MZI delay, the OPM gain, and the feedforward gain are considered to be 1.5 mW, 0.5 [A/W], 0.7 ns, 1[(Rad)/(V)], and 1.5×10¹² [(1)/(sV)], respectively.

FIG. 24 shows the stochastic simulation of the FFLR scheme reducing the FWHM linewidth of a laser from 2 MHz to 200 KHz in presence of practical nonidealities. The effect of these non-idealities are explained below.

### Feed-Forward Linewidth Reduction Scheme Top-Bench Implementation

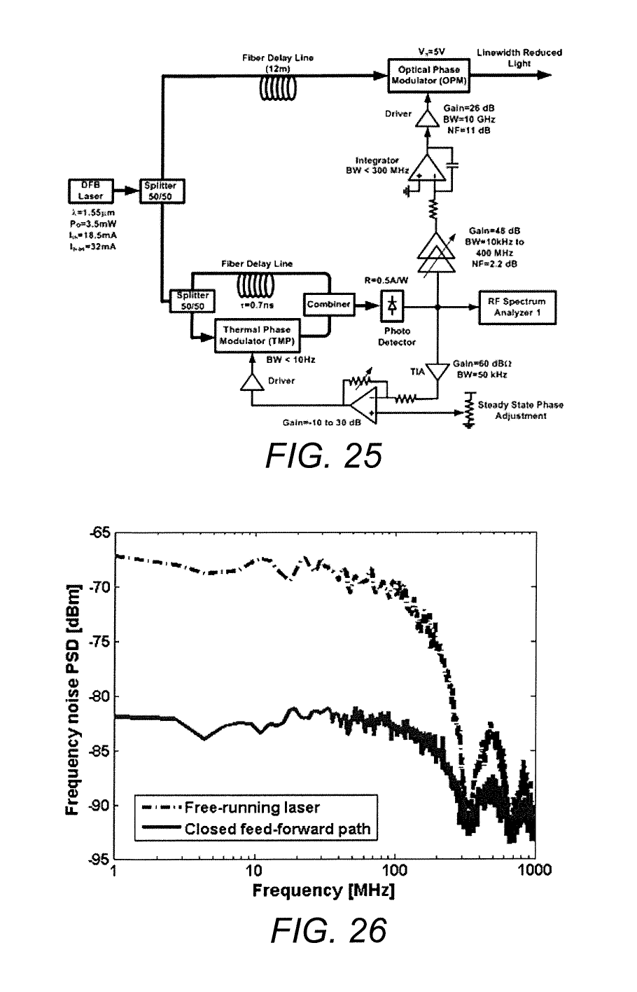

FIG. 25 illustrates a top-bench feed-forward phase noise cancellation scheme for the proposed FFLR scheme. A commercially available 1.55-μm DFB laser with a threshold current of 18.5 mA was used. The output of the laser is split into two to form the main path (top arm) and the feed-forward path (bottom arm). In the feed-forward path, the phase noise of the laser is measured using a delay-line discriminator followed by an integrator. Then, the measured phase noise in the feed-forward path is subtracted from the phase noise in the main branch using a LiNbO₃ optical phase modulator (OPM) with V_{π}≈5 V.

A MZI with 3 ns delay difference between its two arms was placed at the output of the FFLR system to measure the frequency noise of the phase noise reduced light.

FIG. 26 illustrates measured discriminated frequency noise with and without applying the feed-forward signal in FIG. 25. The frequency noise cancellation is depicted in FIG. 26 where the laser frequency noise is reduced by about 14 dB using FFLR scheme. Frequency noise cancellation bandwidth is limited by the electronic circuitry bandwidth. By using electronic circuitry with larger bandwidth, the cancellation bandwidth increases.

Using the self heterodyne method (D. Derickson, Fiber Optic Test and Measurement. Englewood Cliffs, N.J.: Prentice-Hall, 1997) with 25 km of single-mode optical fiber and at 100-MHz offset frequency, the heterodyne power spectrum of the photodiode current was measured.

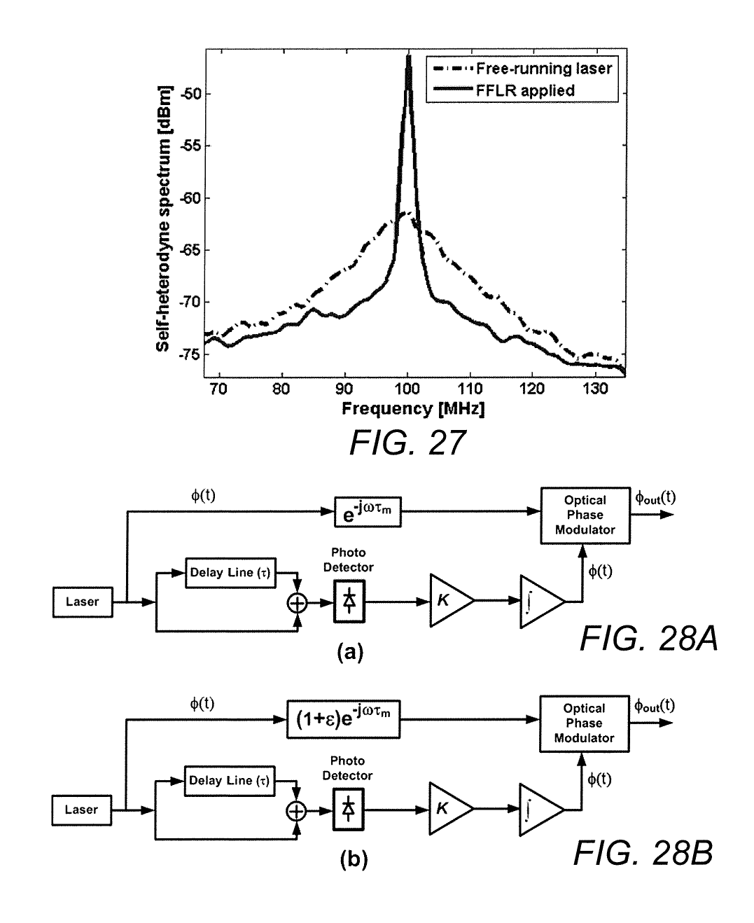

FIG. 27 illustrates a measured self-heterodyne spectrum with and without applying the feed-forward signal in FIG. 25. FIG. 27 shows the heterodyne power spectrum of the photodiode current before and after cancellation. The DFB laser is biased at 32 mA. The FWHM linewidth of the power spectrum of the photodiode current is reduced from 10.4 MHz to about 960 kHz. (For a low-flicker noise laser, the laser FWHM linewidth may be approximated with the measured FWHM linewidth of the photodiode PSD divided by 4.)

### Feed-Forward Linewidth Reduction Design Challenges

Consider the block diagram of the FFLR scheme depicted in FIG. 22. Based on (4), and assuming OPM with gain of unity, for ideal phase noise cancellation, the gain of the amplifier in FIG. 22, K, must be set to (1)/(Rτ\sqrt{P₁P₂}). Ideally, the feed-for ward scheme should be able to cancel the phase noise of a laser completely within the system bandwidth. However, in practice, the nonidealities, as described below, limit the laser phase noise cancellation (or equivalently laser linewidth reduction).

### A. Electrooptical Nonidealities

FIGS. 28A and 28B illustrate a mismatch between the measured laser noise in phase and the original laser noise in phase. FIG. 28A illustrates only delay mismatch, and FIG. 28B illustrates gain and delay mismatches.

Consider the case where there is a delay difference between the discriminated laser noise in phase and the original laser noise in phase at the input of the optical phase modulator as it is depicted in FIG. 28A. In order to investigate the effect of the delay mismatch on the phase noise cancellation, the transfer function from the noise in phase of the laser φ(ω) to the noise in phase of the light at the output of the optical phase modulator φₒᵤₜ(ω) can be written leading to the relationship between the power spectral density of φ(ω) and φₒᵤₜ(ω) as

$$\begin{matrix}{S}_{{φ}_{out}} ( ω ) = 4 {sin}^{2} ( \frac{{ωτ}_{m}}{2} ) & {S}_{φ} ( ω )\end{matrix} \qquad ( 8 )$$

where τₘ is the delay mismatch between the measured laser noise in phase and the original laser noise in phase. Equation (8) indicates that the delay mismatch does not change the amount of the phase noise cancellation but the full cancellation occurs periodically at f=1/τₘ.

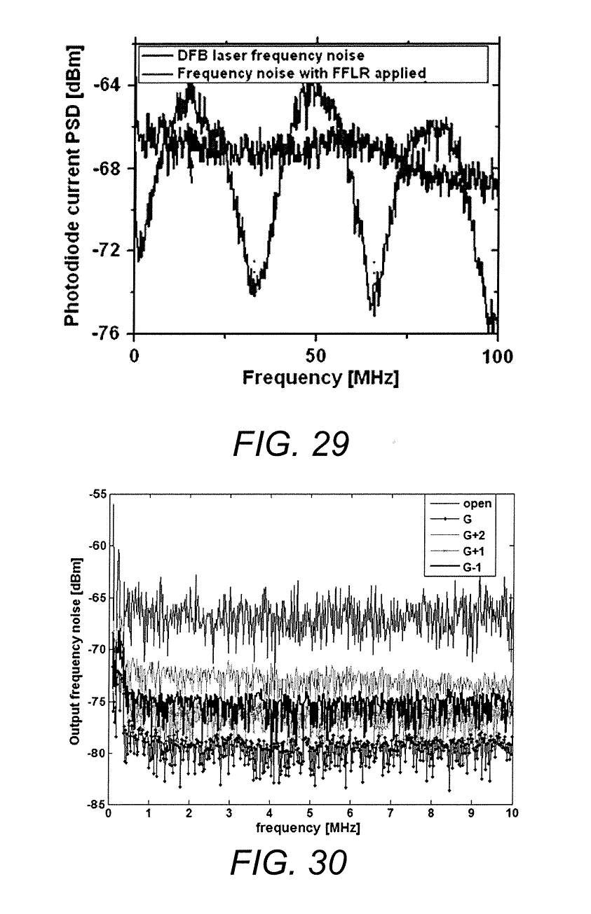

FIG. 29 illustrates a measured effect of a delay mismatch between the main and feed-forward arms in FIG. 25. FIG. 29 shows the effect of about 44 ns of delay mismatch between the main and feed-forward arms, due to delay in the optical fiber and bandwidth of the electronic circuitry. As predicted by (8), the null spacing in FIG. 29 is inverse of the delay mismatch. The delay mismatch is compensated by adding about 12 m of optical fiber to the main arm.

In order to fully cancel the phase noise, the feed-forward path should have unity gain and any deviations from this condition limits the phase noise cancellation. FIG. 28B shows the FFLR scheme block diagram in presence of both delay and gain mismatches. In this case, the power spectral density of φₒᵤₜ(ω) is written as

$${S}_{{φ}_{out}} ( ω ) = [ {ε}^{2} + 4 ( 1 + ε ) {sin}^{2} ( \frac{{ωτ}_{m}}{2} ) ] {S}_{φ} ( ω ) \qquad ( 9 )$$

where ε is the gain mismatch factor. In case of no delay mismatch, the maximum amount of phase noise cancellation is limited by the gain mismatch as

S_{φ}_{ₒᵤₜ}(ω)=ε²S_{φ}(ω) (10)

For example, if ε=0.2, the phase noise cancellation is limited to 14 dB.

The PSD of the light at the output of the optical phase modulator can be calculated in terms of the laser frequency noise (detected at the output of the MZI) as M. Ohtsu, M. Murata, and M. Kourogifm, “Noise reduction and subkilohertz linewidth of an AlGaAs laser by negative electrical feedback,” IEEE J. Quantum Electron., vol. 26, no. 2, pp. 231-241, February 1990.

$$\begin{matrix}{S}_{out} ( f ) = 4 Real [ {\int }_{0}^{∞} {e}^{- 2 π ( f - {f}_{0} ) t - 4 {( π t )}^{2} {μ}^{2}} d t ] & ( 11 ) \\ {μ}^{2} = {\int }_{0}^{∞} {S}_{v} ( f ) \frac{{sin}^{2} ( π f t )}{{( π f t )}^{2}} d f & ( 12 )\end{matrix}$$

And Sᵥ(f) is the PSD of the frequency noise at the output of the MZI. Equations (11) and (12) are valid only if φ(t) is a Gaussian process. Sᵥ(f) for the light at the output of the optical phase modulator can be calculated from S_{φ}_{ₒᵤₜ}(f) since Sᵥ(f)=(2πf)²S_{φ}_{ₒᵤₜ}(f). In the presence of the gain mismatch, Sᵥ(f)= [symbol] ²C and thus the PSD of the light at the output of the OPM can be written as

$${S}_{out} ( f ) = \frac{2 C}{{( f - {f}_{0} )}^{2} + {π}^{2} {ε}^{2} {C}^{2}} . \qquad ( 13 )$$

Equation (13) indicates that the gain mismatch does not change the shape of the output light PSD. The Lorentzian linewidth of the output light PSD is ε² times the original laser linewidth. Thus, in case of no gain mismatch, the linewidth of the output light PSD is zero corresponding to full phase noise cancellation.

FIG. 30 illustrates a measured effect of the gain mismatch between the main and feed-forward arms in FIG. 25. The feedforward path gain G is varied while the gain in the main path is kept constant. FIG. 30 shows the measured effect of the gain mismatch on the frequency noise of the laser after the FFLR scheme is applied. The effect of the gain mismatch on the frequency noise cancellation follows closely the behavior predicted by (10).

The Mach-Zehnder interferometer has maximum frequency to intensity gain when it is locked at the quadrature point. The slow loop (in FIG. 20) that performs the quadrature locking of the MZI is a first-order type-I control loop and therefore it suppresses the phase fluctuations by the loop gain. Also, the loop is very slow and any variation faster than the loop bandwidth of the slow loop may cause the MZI to deviate from the quadrature point. Assuming that the MZI is slightly off the quadrature point (i.e., ω₀τ=π/2+θ), (5) can be modified to

$${S}_{i , PD} ( ω ) = \frac{{R}^{2} {P}_{1} {P}_{2} {e}^{- {C}_{τ}} C}{{C}^{2} + {ω}^{2}} [ [ cosh ( C τ ) - cos ( ωτ ) ] \times {cos}^{2} ( θ ) + {sin}^{2} ( θ ) [ sinh ( C τ ) - C \frac{sin ( ω τ )}{ω} ] ] . \qquad ( 14 )$$

Assuming τ<<(1/C) and f<<(1/τ), (14) is simplified to S_{i,PD}(ω)=(1/2)R²P₁P₂Cτ²(cos²θ+(1/3)Cτ sin² θ). Therefore, after amplification and integration, the PSD of the noise in phase of the laser right before the OPM is written as

$${S}_{φ} ( ω ) = \frac{C}{{ω}^{2}} {cos}^{2} ( θ ) + \frac{1 {C}^{2} τ}{3 {ω}^{2}} {sin}^{2} ( θ ) . \qquad ( 15 )$$

The second term in (15) is an additional undesired term that increases the phase noise of the laser. In this case, the noise in phase of the light at the output of the OPM will be

$${S}_{{φ}_{out}} ( ω ) = {R}^{2} {P}_{1} {P}_{2} \frac{C}{{ω}^{2}} {sin}^{2} ( θ ) [ 1 - \frac{1}{3} C τ ] . \qquad ( 16 )$$

Assuming Cτ<<1, the linewidth of the light after phase noise cancellation is C sin² (θ). One way to improve the performance of the slow loop is to add an integrator to make it a type-II loop. In this case, the loop locks at quadrature point automatically and no further adjustment is required.

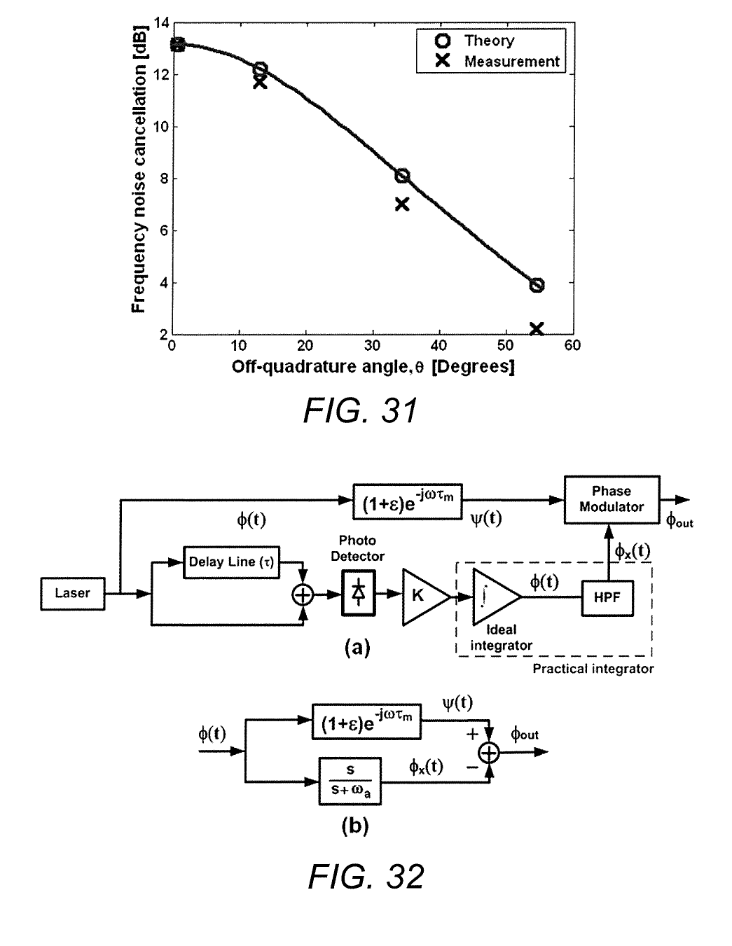

FIG. 31 illustrates a measured and simulated effect of off-quadrature locking of the MZI on the FM noise cancellation. The implemented type-I slow phase adjustment loop reduces the phase fluctuations to 8°, which based on (16), limits the average frequency noise cancellation to 23.2 dB. Assuming 20% gain mismatch in the simulation (corresponding to 14-dB best frequency noise cancellation), the effect of the off-quadrature locking of the MZI on the frequency noise cancellation is measured and compared with the theory in FIG. 31.

### B. Non-Idealities in the Electronic Circuitry

Since the ideal integrator is not a bounded-input bounded-output (BIBO) stable system, it can not be realized in practice over a wide spectral range. A practical integrator is a low pass filter and therefore the integrator does not function properly below a certain frequency, fₐ.

FIG. 32A illustrates two sources of non-idealities, namely, a non-ideal integrator modeled as an ideal integrator in series with a high pass filter, and an amplitude and delay mismatch between the discrimination and cancellation paths. FIG. 32B illustrates a simplified model for a system with these non-idealities. FIG. 32 shows how a non-ideal integrator (a low pass filter) can be modeled as an ideal integrator cascaded with a high pass filter (i.e., 1/(1+s/wₐ)=(1/s)×s/(1+s/wₐ). This helps studying the effect of non-ideal integrator on the performance of the FFLR scheme.

The PSD of noise in phase of the light at the output of the OPM in presence of gain mismatch, small delay mismatch, and non-ideal integrator can be written as

$${S}_{{φ}_{out}} ( ω ) \approx [ \frac{( {ε}^{2} + 2 {ω}_{a} {τ}_{m} ) {ω}^{2} + {ω}_{a}^{2}}{{ω}^{2} + {ω}_{a}^{2}} ] {S}_{φ} ( ω ) . \qquad ( 17 )$$

Equation (17) indicates that for a small delay mismatch, corner frequency of the non-ideal integrator only affects the low frequency profile of the laser frequency noise. However, since most of the energy of the noise in phase is concentrated at low frequencies, it is important to push the corner frequency of the integrator towards DC. Considering only the effect of the non-ideal integrator, (17) is simplified to

$${S}_{{φ}_{out}} ( ω ) = [ \frac{{ω}_{a}^{2}}{{ω}^{2} + {ω}_{a}^{2}} ] {S}_{φ} ( ω ) . \qquad ( 18 )$$

Using (11) and (12), the variance of the noise in phase of the light at the output of the OPM can be obtained as

σₒᵤₜ²=C[1−r(fₐ)]t (19)

where r(fₐ)=(1−e^{-2πf}^{ₐ}^{t})/(2πfₐt) and Ct is the variance of noise in phase of the original laser. Equation (19) indicates that the PSD of the output light is not Lorentzian since its variance is not a linear function of time. Therefore, linewidth is not an accurate metric for the noise performance of the system. Also as fₐ approaches zero, σₒᵤₜ² approaches zero corresponding to full phase noise cancellation and as fₐ approaches infinity σₒᵤₜ², approaches Ct corresponding to no phase noise cancellation as expected. Regardless of the value t>0,r(fₐ)ε(0,1] of is a monotonically decreasing function of fₐε[0,∞). Thus, it is desired to make fₐ as small as possible to reduce the output phase noise power (noise variance) resulting in an improved phase noise cancellation.

In order to study the effect of the corner frequency of the integrator on the linewidth reduction, the corner frequency of the integrator is increased and the canceled linewidth is measured. Stochastic simulations were performed for the same measurement setup.

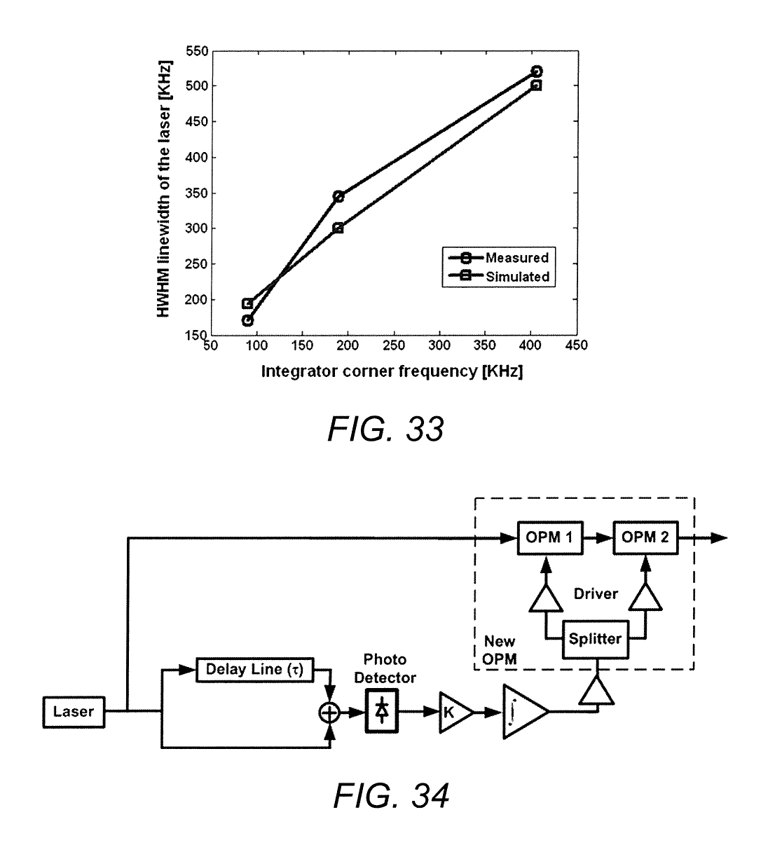

FIG. 33 illustrates a measured and simulated effect of the integrator corner frequency on linewidth reduction (laser biased at 40 mA).

Besides the low-frequency corner of the integrator, another factor that limits the low-frequency performance of the FFLR scheme is the voltage swing of the OPM in the feed-forward path. Assuming that the OPM has a gain G_{OPM} from the input voltage to the output optical phase, the RMS voltage level at the electrical input of the OPM can be calculated as

$$V = \frac{1}{{G}_{OPM}} \sqrt{{\int }_{0}^{∞} \frac{C}{{ω}^{2} + {ω}_{a}^{2}} d ω} = \frac{1}{{G}_{OPM}} \sqrt{\frac{π C}{2 {ω}_{a}}} \qquad ( 20 )$$

where wₐ is the low frequency corner of the integrator. Equation (20) indicates that the voltage level increases as the low frequency corner of the integrator decreases. The electrical input of the OPM is usually matched to an impedance (e.g., 50Ω) which together with its power handling sets the maximum allowable voltage level at the input of the OPM. Thus, the maximum voltage swing at the input of the OPM limits the lowest frequency that the FFLR scheme can operate. For example, if the OPM has gain of π/5 [Rad/V], maximum input power handling of 27 dBm, and 50-Ω input matching, under the ideal condition, the low corner frequency of the integrator can not be set to a value smaller than 160 KHz when the original laser linewidth is 2 MHz. In the case that the phase noise cancellation is performed at low frequencies, where the 50-Ω matching of the input of OPM is not required, the input impedance of the OPM can be set to higher values to improve the swing handling of the OPM.

FIG. 34 illustrates cascaded OPMs to improve the linewidth reduction. FIG. 34 shows the FFLR scheme when two identical OPMs are connected in series in the optical domain and placed in parallel in the electrical domain. In this case, an OPM with higher gain is formed which equivalently results in larger C/ωₐ ratio corresponding to better linewidth reduction.

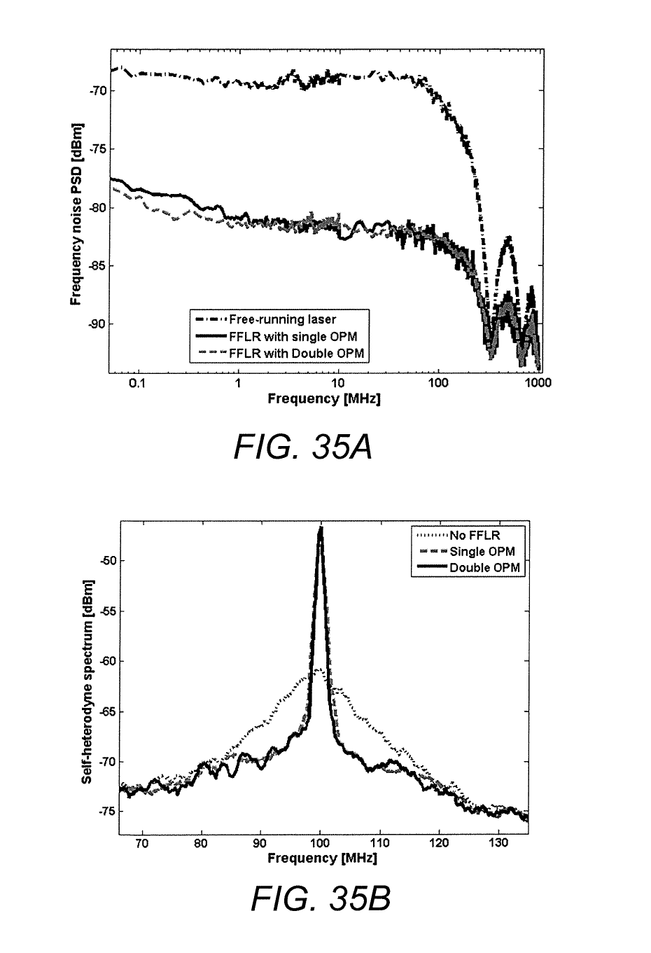

FIGS. 35A and 35B illustrate phase noise cancellation improvement when a single OPM is replaced by two cascaded OPMs. FIG. 35A illustrates measured frequency noise comparison, and FIG. 35B illustrates measured linewidth reduction comparison. FIGS. 35A and 35B show the measured frequency noise reduction and linewidth reduction improvement for the case that in the FFLR scheme, the single OPM is replaced by two cascaded OPMs in the optical domain. A 36% linewidth reduction improvement is measured when the single OPM is replaced by two cascaded OPMs.

### C. Added Noise

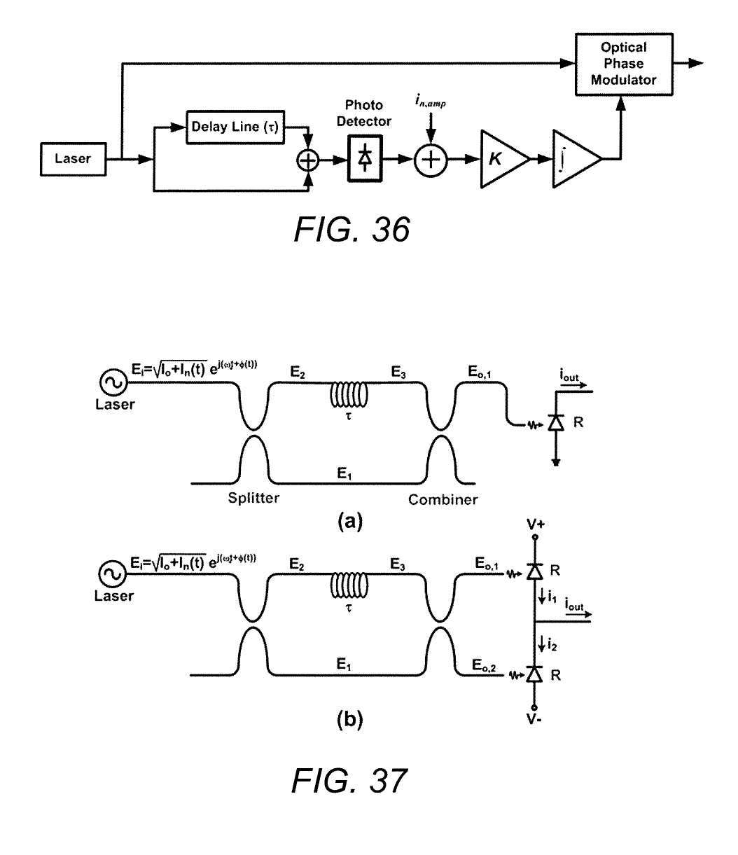

FIG. 36 illustrates the effect of the electronic circuitry noise on the FFLR scheme performance. The electronic circuitry in the FFLR scheme generates noise that limits the laser phase noise cancellation. Assuming that the noise in the electronic circuitry can be referred to its input as i_{n,amp} (FIG. 18), there will be a lower bound for the laser linewidth after applying FFLR as

$${C}_{canceled} \geq {S}_{{i}_{n , amp}} ( ω ) \frac{1}{{R}^{2} {τ}^{2} {P}_{1} {P}_{2}} \qquad ( 21 )$$

where Sᵢ_{_{n,amp}} (ω) is the power spectral density of the equivalent input referred current noise of the electronic circuitry. Although (21) indicates that larger delay reduces the canceled linewidth, it reduces the noise cancellation bandwidth as (7) suggests. For example, for photodiode responsivity 0.8(A/W), P₁=P₂=1 mW, i_{n,amp}=20 pA/\sqrt{Hz} (corresponding to 1 nV/\sqrt{HZ} or noise figure of 3 dB in a 50-Ω system), and delay difference of 3 ns between two arms of MZI, the smallest achievable laser linewidth using FFLR scheme is about 70 Hz.

Now, consider the effect of the laser intensity noise in the proposed scheme. Consider the laser field to have the form of [symbol] ᵢ [symbol] \sqrt{I₀+Iₙ}e^{j(ω}^{₀}^{t+φ(t))}, where I₀, Iₙ, ω₀, and Φ(t) are the average laser intensity, the intensity fluctuations, the optical frequency, and the optical phase fluctuations, respectively. In this case, the laser relative intensity noise (RIN) is defined as

$$RIN = \frac{\overline{{I}_{n}^{2}}}{{I}_{0}^{2}} . \qquad ( 22 )$$

In order to investigate the effect of the amplitude noise, it is useful to consider the frequency discriminator in more detail.

FIGS. 37A and 37B illustrate the RIN effect in frequency noise discrimination. FIG. 37A illustrates single photodiode detection, while FIG. 37B illustrates balanced photodiode detection.

FIG. 37A shows the frequency discriminator which is used in the FFLR scheme. The frequency discriminator consists of two couplers that are used as a splitter and a combiner. Assuming that the MZI is lossless, the photodiode current can be written as G. L. Abbas, V. W. S. Chan, and T. K. Yee, “A dual-detector optical heterodyne receiver for local oscillator noise suppression,” J. Lightw. Technol., vol. LT-3, no. 5, pp. 1110-1122, October 1985.

$${i}_{out} ( t ) = \frac{R}{4} [ {I}_{n} ( t ) + {I}_{n} ( t - τ ) ] + {i}_{shot} + \frac{R}{2} {I}_{0} \times [ 1 - \sqrt{( 1 + \frac{{I}_{n} ( t )}{{I}_{0}} ) ( 1 + \frac{{I}_{n} ( t - τ )}{{I}_{0}} )} \times cos ( {ω}_{0} τ + φ ( t ) - φ ( t - τ ) ) ] \qquad ( 23 )$$

Where τ and iₛₕₒₜ are the MZI delay and the photodiode shot noise, respectively. The laser RIN generates an equivalent noise current at the output of the MZI. Defining i_{RIN}=R[Iₙ(t)+Iₙ(t−τ)], and assuming Iₙ to be a mean-zero additive white Gaussian noise (AWGN),

$$\overline{{i}_{RIN}^{2}} = {R}^{2} \overline{{( {I}_{n} ( t ) + {I}_{n} ( t - τ ) )}^{2}} = 2 {R}^{2} \overline{{I}_{n}^{2} ( t )} = 2 {R}^{2} {I}_{0}^{2} RIN .$$

Therefore (23) is modified to

$${i}_{out} ( t ) \approx \frac{R}{2} {I}_{0} [ 1 - cos ( {ω}_{0} τ + φ ( t ) - φ ( t - τ ) ) ] + \frac{1}{4} {i}_{RIN} + {i}_{shot} \qquad ( 24 )$$

where Iₙ<<I₀ is assumed. Note that i_{DC}=(R/2)I₀. Equation (24) indicates that the effect of the laser RIN and photodiode shot noise can be modeled similar to the input referred current noise of the electronic circuitry. In other words, defining iₜₒₜₐₗ=i_{electrical}+(1/4)i_{RIN}+iₛₕₒₜ, (21) is modified to

$${C}_{canceled} \geq {S}_{{i}_{total}} ( ω ) \frac{1}{{R}^{2} {τ}^{2} {P}_{1} {P}_{2}} \qquad ( 25 )$$

where

$${S}_{{i}_{total}} ( ω ) = \overline{{i}_{electrical}^{2}} + \overline{{i}_{shot}^{2}} + ( 1 / 2 ) {i}_{DC}^{2} RIN .$$

For example, RIN=−134 dB/Hz results in

$$\sqrt{\overline{{i}_{RIN}^{2}}} = 200 pA / \sqrt{Hz}$$

which could be an order of magnitude larger than the typical equivalent input referred current noise of the electrical circuitry.

FIG. 37B shows the balanced detection scheme used in frequency discrimination where two output of the optical combiner illuminate two identical photodiodes and their electrical currents are subtracted. In this case, the electrical currents in each photodiodes can be calculated as

$$\begin{matrix}{i}_{1} ( t ) = \frac{R}{2} {I}_{0} [ 1 - cos ( {ω}_{0} τ + φ ( t ) - φ ( t - τ ) ) ] + \frac{1}{4} \underbrace{R ( {I}_{n} ( t ) + {I}_{n} ( t - τ ) )}_{{i}_{RIN , 1}} + {i}_{shot , 1} , & ( 26 ) \\ {i}_{2} ( t ) = \frac{R}{2} {I}_{0} [ 1 + cos ( {ω}_{0} τ + φ ( t ) - φ ( t - τ ) ) ] + \frac{1}{4} \underbrace{R ( {I}_{n} ( t ) + {I}_{n} ( t - τ ) )} + {i}_{shot , 2} . & ( 27 )\end{matrix}$$

Thus, the output current iₒᵤₜ=i₁−i₂ can be written as

$${i}_{out} ( t ) = R {I}_{0} cos ( {ω}_{0} τ + φ ( t ) - φ ( t - τ ) ) + \frac{1}{4} {\underbrace{( {i}_{RIN , 1} - {i}_{RIN , 2} )}}_{Correlated} + \underbrace{{i}_{shot , 1} - {i}_{shot , 2}}_{Uncorrelated} . \qquad ( 28 )$$

The term (i_{RIN,1}−i_{RIN,2}) appears as the common mode signal and is completely rejected for fully balanced detection. The photodiodes shot noise are uncorrelated and are not rejected in the balanced detection scheme. Therefore, the detected current can be simplified to

iₒᵤₜ(t)=RI₀ cos(ω₀τ+φ(t)−φ(t−τ))+iₛₕₒₜ (29)

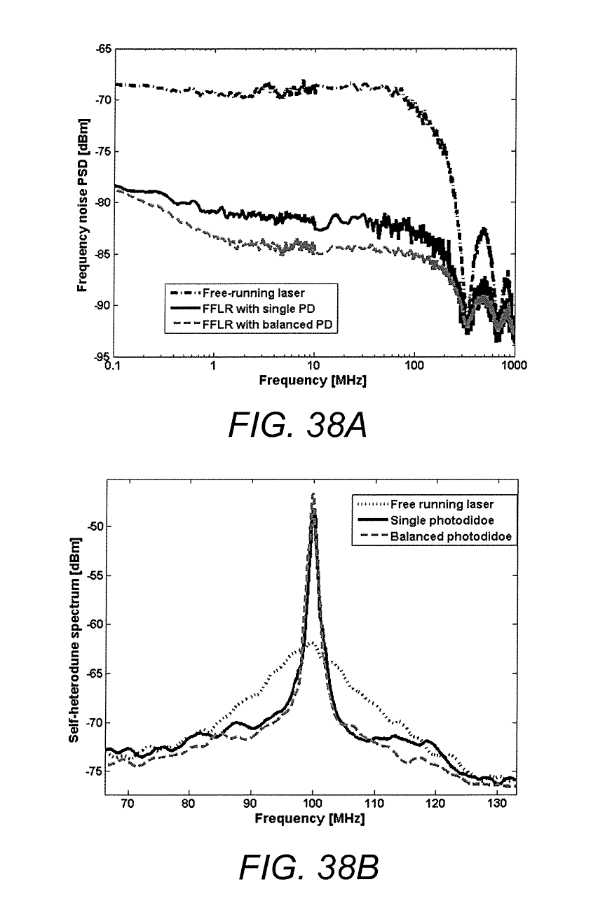

FIGS. 38A and 38B illustrate the effect of the balanced photodiode on the frequency noise reduction (FIG. 38A) and linewidth reduction (FIG. 38B). FIGS. 38A and 38B shows the measured frequency noise and linewidth reduction when the single photodiode is replaced with a balanced photodiode. The balanced photodiode has the −3-dB bandwidth of better than 1 GHz and the responsivity of each diode is 0.9 A/W. Although the RIN suppression in the balanced photodiode improves the frequency noise cancellation by more than 2 dB, less than 10% improvement was observed in the laser linewidth reduction as the linewidth reduction is limited by the maximum allowable swing at the input of the optical phase modulator.

### Improved FFLR Scheme and Complementary Measurement Results

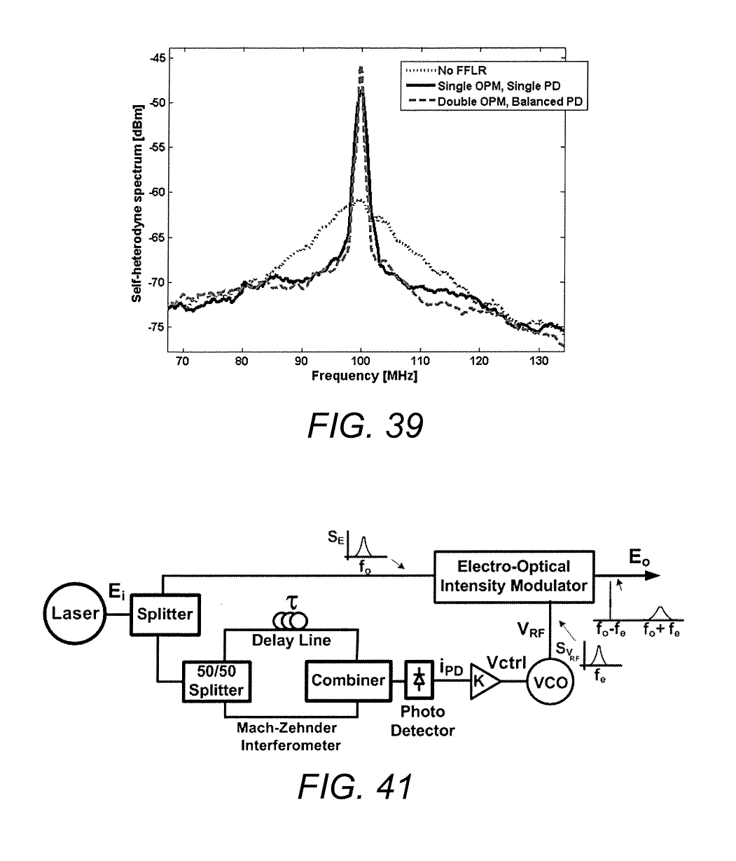

FIG. 39 illustrates measured linewidth reduction when both balanced photodiodes and cascaded OPMs are used in FFLR scheme. FIG. 39 shows the linewidth reduction for the case that balanced photodiodes together with cascaded OPMs are used in the FFLR scheme. In this case, for the laser biased at 32 mA, the FWHM linewidth of the photodiode current power spectral density is reduced by more than 18 times.

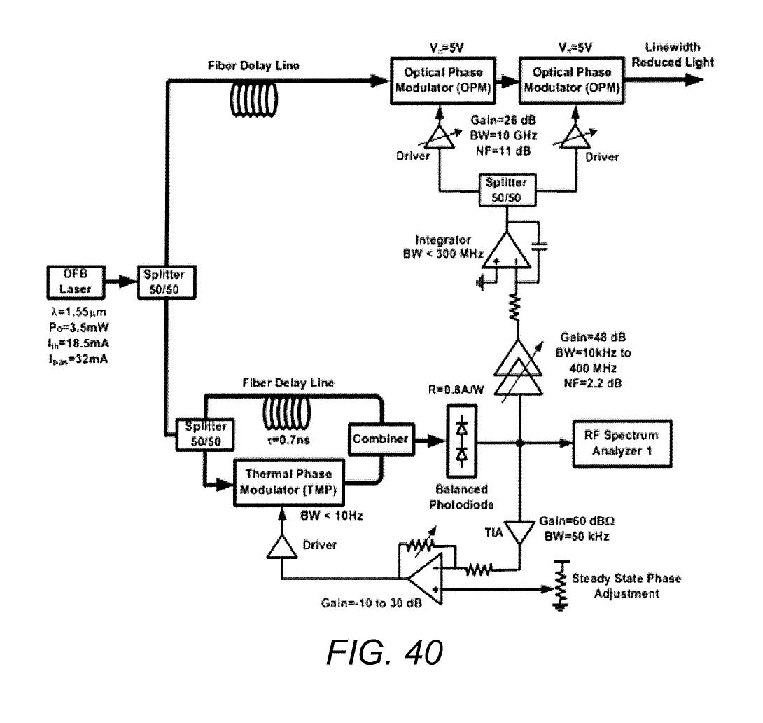

FIG. 40 illustrates top-bench feed-forward phase noise cancellation scheme with balanced detection and cascaded OPMs.

The linewidth reduction achieved with different FFLR architectures is summarized in Table I:

TABLE 1
COMPARISON OF DIFFERENT FFLR ARCHITECTURES

| | FWHM linewidth of | |
|---|---|---|
| Architecture/condition | the current PSD | |
| Free-running Laser | 10.4 | MHz |
| Single | 960 | KHz |
| Balanced photodiode and single OPM | 880 | KHz |
| Single photodiode and double OPMs | 620 | KHz |
| Balanced photodiode and double OPMs | 560 | KHz |

Linewidth reduction from 2.6 MHz to 140 KHz achieved by the FFLR scheme improves the estimated resolution of the coherent LIDAR discussed in M. C. Amann, “Phase noise limited resolution of coherent LIDAR using widely tunable laser diodes,” Electron. Lett., vol. 28, no. 78, August 1992 from 28 μm to 6.5 μm (for the 10-m range) and reduces the estimated BER of the 16-QAM scheme reported in K. Gao, J. Wang, L. Yang, X. He, D. Peterson, and Z. Pan, “Local oscillator linewidth limitation on 16 QAM coherent optical transmission system,” IEEE-OSA CLEO, no. JThE64, 2010 from 6×10⁻³ to 10⁻⁵ when a 40 Gb/s signal is transmitted over the 315-km range.

The performance of this work is compared with that of a few published works in Table II:

TABLE II
THE FFLR PERFORMANCE COMPARISON WITH A FEW PUBLISHED WORKS

| | | | | | Noise | | | |
|---|---|---|---|---|---|---|---|---|
| | Original | | Output | | Cancellation | | | |
| Reference | Linewidth | | Linewidth | | Bandwith | | Laser Type | Scheme |
| R. D. Esman and K. Iwashita, | 19 | MHz | 8 | MHz | 1 | GHz | DFB | Feed- |
| “High-frequency optical FM | | | | | | | | Forward |
| noise reduction employing a | | | | | | | | |
| fiber-insertable feed-forward | | | | | | | | |
| technique,” in Dig. Conf. | | | | | | | | |
| Optical Fiber Commun., vol. | | | | | | | | |
| 5, OSA Tech. Dig. Series | | | | | | | | |
| (Optical Society of America, | | | | | | | | |
| 1992), paper TuM3 | | | | | | | | |
| M. Kourogi, C. H. Shin, and M. | 2 | MHz | 250 | Hz | 10 | KHz | DFB | Electrical |
| Ohtsu, “A 250 Hz spectral | | | | | | | | Feedback |
| linewidth 1.5 prn MQW-DFB | | | | | | | | |
| laser diode with negative- | | | | | | | | |
| electrical-feedback,” IEEE | | | | | | | | |
| Photon. Technol. Lett., vol. 3, | | | | | | | | |
| no. 6, pp. 496-498, June 1991 | | | | | | | | |
| C. H. Shin and M. Ohtsu, | 10 | KHz | 7 | Hz | 1.5 | MHz | CFP | Electrical |
| “Stable semiconductor laser | | | | | | | Semiconductor | and Optical |
| with a 7-Hz linewidth by an | | | | | | | Laser | Feedback |
| optical-electrical double- | | | | | | | | |
| feedback technique,” Opt. | | | | | | | | |
| Lett., vol. 15, no. 24, pp. | | | | | | | | |
| 1455-1457, 1990 | | | | | | | | |
| This work | 2.6 | MHz | 140 | KHz | 330 | MHz | DFB | Feed- |
| | | | | | | | | Forward |

In comparison with other linewidth reduction schemes, the FFLR is independent of the light source and therefore the laser characteristics does not affect the phase noise cancellation performance while in feedback based phase noise cancellation schemes, the laser is a part of the feedback loop and its characteristics (such as FM response) may affect the phase noise cancellation profile. Also, since there is no feedback action in the FFLR scheme, the instability due to operation over a large bandwidth is not an issue. Large phase noise cancellation bandwidth is an important factor in terms of the spectral purity in several applications. For example, in mm-wave generation based on beating of two lasers, phase noise profile of the beat note is directly set by the noise cancellation profile of two lasers. Small noise cancellation bandwidths (e.g., when electrical feedback scheme is used), increases the time jitter of the generated mm-wave tone.

### FFLR System Integration

On-chip micro-ring resonators together with integrated optical waveguides can be used to integrate the FFLR scheme on a monolithic chip with low-noise transistors having THz gain-bandwidth product. At a wavelength of 1.55 μm, a delay of 1 ns can be created with a micro-ring resonator with quality factor of Q=6×10⁵. Also active micro-ring resonators K. Djordjev, S. Choi, S. Choi, and P. D. Dapkus, “Active semiconductor microdisk devices,” J. Lightw. Technol., vol. 20, no. 1, pp. 105-113, January 2002 can be used as on-chip optical phase modulators.

Since the on-chip optical delay element is lossy, the amount of the optical delay placed in the main arm of the FFLR scheme, compensating for the delay of the feed-forward path, should be minimized. Thus, the equivalent delay of the electronic circuitry in the feed-forward path should be small corresponding to large bandwidth of the electronics. For example, for the FFLR system in FIG. 4 and for the MZI delay of 1 ns, the electrical delay should be much smaller than the MZI delay (e.g., τ_{electrical} 100 ps), Therefore, it is required for the on-chip electronic circuitry to operate across 10 GHz of bandwidth with a large gain, indicating that transistors with THz gain-bandwidth product are required for on-chip implementation of the FFLR scheme.

In comparison with the top-bench setup, the integrated FFLR scheme will be less sensitive to environment variations, has less power consumption, and occupies much smaller area. Also such an integration enables using various electrical and optical techniques to further improves the laser linewidth reduction.

### Overview and Summary

An analysis of feed-forward linewidth reduction scheme for semiconductor lasers followed by measurements has been presented. The experiments were carried out on a commercially available 1.55-m distributed feedback (DFB) laser. The measurement results show more than 40 times reduction in frequency noise power spectrum. Also the laser original full-width at half-maximum (FWHM) linewidth of 2.6 MHz is reduced to less than 140 KHz. The feed-forward scheme does not have the limited noise cancellation bandwidth, instability, and speed issues that are common in feedback linewidth reduction systems. In this scheme, the ultimate achievable phase noise may be limited by the noise of electronic circuitry and laser intensity noise. Using the proposed feed-forward approach, the frequency noise of semiconductor lasers can be reduced by 3-4 orders of magnitude in a monolithic approach using today's low-noise scaled transistors with THz gain-bandwidth product.

The reduction of semiconductor laser phase noise has been demonstrated by using an electrical feed-forward scheme. Several sources for non-idealities in the electrical and optical domains have been explained, and analysis and measurements have been performed to understand and reduce these non-ideal effects. The effect of the relative intensity noise of the laser was reduced by employing the balanced detection which led to 2 dB improvement in the frequency noise cancellation. Also cascading two optical phase modulators increases the maximum voltage swing handling in the electrical domain leading to 36% improvement in linewidth reduction. The final measurement results after reducing the effect of the nonidealities show more than forty times reduction in frequency noise power spectrum and more than 18 times reduction in laser linewidth. The feed-forward scheme does not have the limited noise cancellation bandwidth, stability and speed issues that are common in feedback systems. Also, unlike feedback phase noise reduction schemes, the feed-forward linewidth reduction scheme does not depend on the laser source and in principle, can be placed after a light source to reduce its phase noise. The proposed feed-forward phase noise cancellation scheme can be integrated on a single electrooptical chip to reduce the sensitivity to the environment variations while occupying small area and consuming low power.

### The PSD of the Photodiode Current

From (1), the photodiode current can be written as iₒᵤₜ=R\sqrt{P₁P₂}u(t) where

u(t)=cos(ω₀τ_{d}+φ(t)−φ(t−τ_{d})) (30)

and φ(t) is a mean-zero Gaussian random walk with a variance that is linearly increasing with time

$$( i . e . , σ \frac{2}{σ} = Ct ) .$$

The goal is to find the PSD of u, Sᵤ(w). Consider the random process U(t) as

U(t)=e^{j(ω}^{₀}^{τ}^{_{d}}^{+φ(t)-φ(t-τ}^{_{d}}⁾⁾ (31)

The expected value of precess U can be calculated as

[symbol]

[U(t)]=e^{jω}^{₀}^{τ}^{_{d}} [symbol] [e^{j(φ(t)-φ(t-τ}^{_{d}}⁾⁾] (32)

Defining x(t) [symbol] φ(t)−φ(t−τ_{d}),x is a Gaussian process and using the definition of the characteristic function of a Gaussian process A. Leon-Garcia, Probability and Random Processes for Electrical Engineering, 2nd ed. Reading, Mass.: Addison-Wesley, 1994, (32) is modified to

[symbol]

[U(t)]=e^{jω}^{₀}^{τ}^{_{d}}e^{-1/2σ}^{²}^{ₓ} (33)

Knowing that φ(t) is a Gaussian random wlak, it is shown that A. Leon-Garcia, Probability and Random Processes for Electrical Engineering, 2nd ed. Reading, Mass.: Addison-Wesley, 1994

[symbol]

[φ(t)φ(t−τ_{d})]=2Cmin(t,t−τ_{d}) (34)

Therefor, the variance of x(t) can be calculated as

$$\begin{matrix}{σ}_{x}^{2} = E [ {( φ ( t ) - φ ( t - {τ}_{d} ) )}^{2} ] \\ = Ct + C ( t - {τ}_{d} ) - 2 C min ( t , t - {τ}_{d} ) \\ = C \vert {τ}_{d} \vert .\end{matrix} \qquad ( 35 )$$

Thus, (33) is modified to

$$\begin{matrix}E ( U ( t ) ] = {e}^{{jω}_{0} {τ}_{d}} {e}^{- \frac{1}{2} C \vert {τ}_{d} \vert} . \\ Then , & ( 36 ) \\ E [ u ( t ) ] = \frac{1}{2} E [ U ( t ) + {U}^{*} ( t ) ] = cos ( {ω}_{0} τ ) {e}^{- \frac{C}{2} \vert {τ}_{d} \vert} . & ( 37 )\end{matrix}$$

The autocorrelation function of u(t) can be calculated as

$${R}_{u} ( {t}_{2} , {t}_{1} ) = \frac{1}{4} E [ ( U ( {t}_{2} ) + {U}^{*} ( {t}_{2} ) ) ( U ( {t}_{1} ) + {U}^{*} ( {t}_{1} ) ) ] . \qquad ( 38 )$$

Defining z₁ [symbol] ^{φ(t}^{₁}⁾−φ(t₁−τ_{d}) and z₂ [symbol] ^{φ(t}^{₂}⁾−φ(t₂^{-τ}^{_{d}}⁾, it can be seen that

[symbol]

[U(t₂)U*(t₁)]= [symbol] [e^{j(z}^{₂}^{-z}^{₁}⁾] (39)

and

[symbol]

[U(t₁)U(t₂)]=e^{j2ω}^{₀}^{τ}^{_{d}} [symbol] [e^{j(z}^{₂}^{+z}^{₁}⁾] (40)

Without loss of generality, it can be assumed that t₁<t₂−τ_{d}, z₁ and z₂ are uncorrelated which indicates that

[symbol]

[e^{j(z}^{₂}^{+z}^{₁}⁾]= [symbol] [e^{jz}^{₁}] [symbol] [e^{jz}^{₂}]=e^{-Cτ}^{_{d}} (41)

and

[symbol]

[e^{j(z}^{₂}^{-z}^{₁}⁾]= [symbol] [e^{-jz}^{₁}] [symbol] [e^{jz}^{₂}]=e^{-Cτ}^{_{d}} (42)

In the second case, t₁>t₂−τ_{d} and thus z₁ and z₂ are correlated. In this case it is helpful to rewrite z₁ and z₂ as follows:

$$\begin{matrix}{z}_{1} = {\underbrace{φ ( {t}_{2} - {τ}_{d} ) - φ ( {t}_{1} - {τ}_{d} )}}_{P} + {\underbrace{φ ( {t}_{1} ) - φ ( {t}_{2} - {τ}_{d} )}}_{Q} , \\ and & ( 43 ) \\ {z}_{2} = {\underbrace{φ ( {t}_{1} ) - φ ( {t}_{2} - {τ}_{d} )}}_{Q} + {\underbrace{φ ( {t}_{2} ) - φ ( {t}_{2} )}}_{S} . & ( 44 )\end{matrix}$$

Since φ(t) is a mean-zero process, E[P]=E[Q]=E[S]=0. Also, φ(t) is a Wiener process and therefore P, Q, and S are independent since there are no time overlaps between them. From (36) the variance of P, Q, and S can be calculated as

σ_{P}²=σ_{S}²=C|τ|,σ_{Q}²=C(τ_{d}−|τ|) (45)

where τ=t₂−t₁ is assumed. Also,

[symbol]

[e^{j(z}^{₂}^{+z}^{₁}⁾]= [symbol] [e^{jP}] [symbol] [e^{j2Q}] [symbol] [e^{jS}] (46)

Equation (46) together with (45) indicates that

[symbol]

[e^{j(z}^{₂}^{+z}^{₁}⁾]=e^{-C(2τ}^{_{d}}^{-|τ|)} (47)

Similarly,

[symbol]

└e [symbol] ┘=e^{-C|τ|} (48)

Therefore, (39) and (40) are modified to

[symbol]

[U(t₁)U(t₂)]=e^{jτ}^{_{d}}^{(2ω}^{₀}^{-C)}×[Π_{τ}_{_{d}}(τ)(e^{-C(τ}^{_{d}}^{-|τ|)}−1)+1] (49)

[symbol]

[U*(t₁)U(t₂)]=Π_{τ}_{_{d}}(τ)(e^{-C|τ|}−e^{-Cτ}^{_{d}})+e^{-Cτ}^{_{d}} (50)

where Π_{τ}_{_{d}}(τ) is unity for |τ|<τ_{d} and it is zero elsewhere. By combining (38), (49), and (50), the autocorrelation function of u(t) can be calculated as

$${R}_{u} ( {t}_{2} , {t}_{1} ) = \frac{1}{4} {e}^{- C {τ}_{d}} [ cos ( 2 {ω}_{0} {τ}_{d} ) x ( τ ) + y ( τ ) ] \\ where \\ x ( τ ) = 1 + {Π}_{{τ}_{d}} ( τ ) [ {e}^{- C ( {τ}_{d} - \vert τ \vert )} - 1 ] , \\ and \\ y ( τ ) = 1 + {Π}_{{τ}_{d}} ( τ ) [ {e}^{C ( {τ}_{d} - \vert τ \vert )} - 1 ] . \qquad ( 51 )$$

Taking the Fourier transform of (51) and ignoring the DC component results in the PSD of u(t) as

$$\begin{matrix} {S}_{u} ( ω ) = {e}^{- C {τ}_{d}} ( \frac{C}{{C}^{2} + {ω}^{2}} ) M ( ω ) \\ where & ( 52 ) \\ M ( ω ) = [ cosh ( C {τ}_{d} ) - cos ( ω {τ}_{d} ) ] {sin}^{2} ( {ω}_{0} {τ}_{d} ) + [ sinh ( C {τ}_{d} ) - \frac{C}{ω} sin ( ω {τ}_{d} ) ] {cos}^{2} ( {ω}_{0} {τ}_{d} ) . & ( 53 )\end{matrix}$$

Finally, combining (30) and (52) results in the PSD of the photodiode current (5).

### Other Architectures to Reduce the Semiconductor Laser Phase Noise Using Electrical Feed-Forward Schemes

An additional feed-forward phase noise cancellation scheme is now discussed where the conversion of the discriminated optical frequency noise to phase noise is done using an electrical voltage controlled oscillator (VCO). Compared to the scheme in M. Bagheri, F. Aflatouni, A. Imani, A. Goel, and H. Hashemi, Opt. Lett. 34, 2979 (2009), this architecture is not limited by the voltage swing levels in the electrical domain due to VCO's phase wrapping (as the phase appears in the argument of a trigonometric function).

FIG. 41 is a diagram of a phase noise cancellation system. The laser output is split into two branches. In the bottom branch (the feed-forward branch), the frequency noise of the laser (i.e., the derivative of the phase noise) is discriminated using a Mach-Zehnder interferometer (MZI) and photodetector. Assuming that the laser output electric field has the form of Eᵢ=\sqrt{2I₀}e^{j(ω}^{₀}^{t+φ(t))} and the MZI is biased at the quadrature point (i.e., ω₀τ=π/2), the AC part of the photodetector current can be calculated as F. Aflatouni, M. Bagheri, and H. Hashemi, IEEE Trans. Microwave Theory Tech. 58, 3290 (2010).

$${i}_{ac} ( t ) = \frac{R}{2} {I}_{0} cos ( {ω}_{0} τ + φ ( t ) - φ ( t - τ ) ) \approx \frac{R}{2} {I}_{0} τ \frac{d}{d t} φ ( t ) . \qquad ( 54 )$$

where R, I₀, w_{0,φ(t)}, and τ are the photodetector responsivity, the laser intensity, lasing angular frequency, laser phase noise, and the delay difference between the two arms of the MZI, respectively. The photodetector current is amplified and converted to a voltage with a gain of K, and is fed into the control voltage of a VCO. The VCO integrates its control voltage in the phase domain F. M. Gardner, Phaselock Techniques (Wiley, 2005), Chap. 5, that is

$$\begin{matrix}{V}_{RF} ( t ) = A cos ( {ω}_{e} t + {φ}_{e} + {K}_{VCO} \int {V}_{ctrl} ( t ) d t ) \\ = A cos ( {ω}_{e} t + {φ}_{e} + {K}_{VCO} \int K \frac{R}{2} {I}_{0} τ \frac{d φ}{d t} d t ) .\end{matrix} \qquad ( 55 )$$

where V_{RF}(t), A, ωₑ, φₑ(t), K_{VCO}, and V_{ctrl}(t) are the radio frequency (RF) output voltage, oscillation amplitude, oscillation frequency, phase noise, gain, and control voltage of the VCO, respectively. Setting the amplifier gain, K, such that KK_{VCO}=2/RI₀τ, results in V_{RF}⁻=A cos(ωₑt+φₑ(t)+φ((t)) The VCO output drives an electro-optical intensity modulator. Assuming an ideal electro-optical intensity modulation (i.e., Eₒ(t)=\sqrt{Iₒ}e^{j(ω}^{₀}^{t+φ(t))}×A cos [ωₑt+φₑφ(t)]) at the output of the intensity modulator, two tones, at the sum and difference of the optical and electrical frequencies, will be generated. The tone at the sum of two frequencies will have twice of the original phase noise of the laser, while the phase noise of the optical signal at the frequency difference will be ideally canceled, that is

$${E}_{o} ( t ) = \frac{A}{2 j} \sqrt{{I}_{o}} [ {\underbrace{{e}^{j [ ( {ω}_{0} + {ω}_{e} ) t + 2 φ ( t ) + {φ}_{e} ]}}}_{undesired} + {\underbrace{{e}^{j [ ( {ω}_{0} + {ω}_{e} ) t + {φ}_{e} ]}}}_{desired} ] . \qquad ( 56 )$$

Ideally, only the clean tone, at the frequency difference between the laser and the VCO, must remain at the output of the intensity modulator and the other tone must be suppressed.

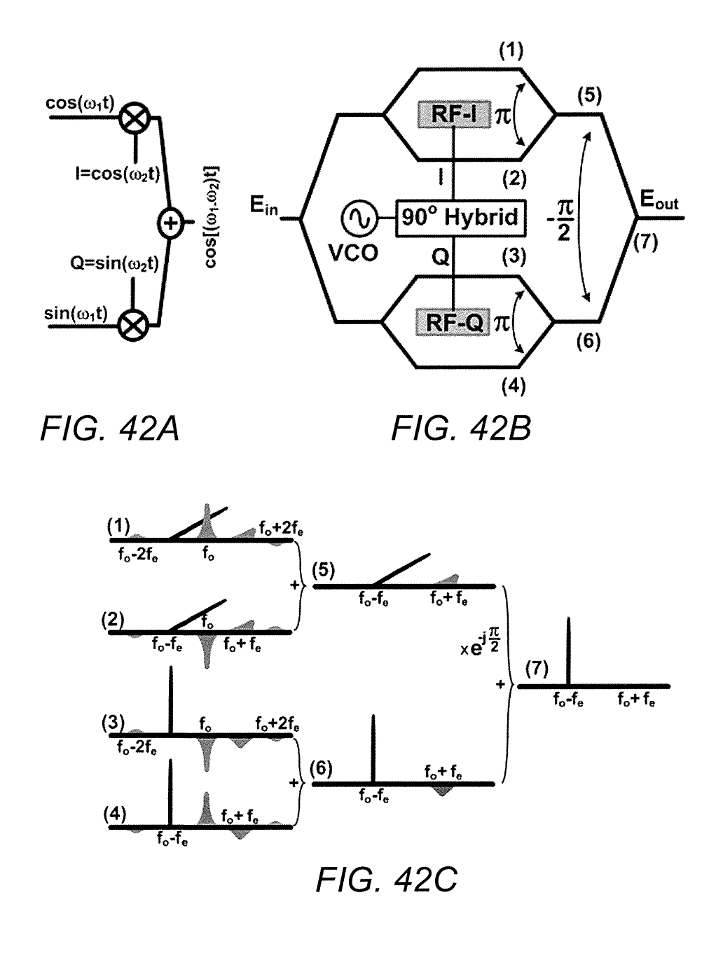

FIG. 42A illustrates an SSB modulation concept; FIG. 42B illustrates an electro-optical SSB modulator block diagram; and FIG. 42C is a graphical representation of SSB action.

FIG. 42A shows a block diagram of an electrical single sideband (SSB) amplitude modulator where two multipliers and a 90° phase-shifted (or quadrature) version of electrical signals are used to eliminate the higher sideband component of the output (at ω₁+ω₂). The same technique may be used to introduce electro-optical SSB modulation S. Shimotsu, S. Oikawa, T. Saitou, N. Mitsugi, K. Kubodera, T. Kawanishi, and M. Izutsu, IEEE Photon. Technol. Lett. 13, 364 (2001). FIG. 42B shows the block diagram of the equivalent electro-optical SSB modulator used to eliminate the undesired components at the output of the linewidth reduction scheme. Two balanced Mach-Zehnder intensity modulators [equivalent to multipliers in FIG. 42A] are nested inside an MZI. The amplified output of the VCO is converted into two signals with 90° phase difference, which drive two balanced intensity modulators. To guarantee the SSB action, the phase difference between two arms of each MZI intensity modulator must be set to 180°, while the two arms of the outer MZI are locked at 90° phase difference. The phase locking of all MZIs is done automatically using a digital controller unit. FIG. 42(c) illustrates the SSB electro-optical modulation principle in a complex frequency plane. Note that the imaginary plane is rotated by 90° with respect to the real plane to ease the illustration. Phase modulation of the optical signal generates Bessel sidebands P. C. D. Hobbs, Building Electro-Optical Systems (Wiley, 2000), Chap. 13.3 according to the optical and electrical phases at points (54), (55), (56), and (57). In the top MZI, balanced phase modulation of the light results in the suppression of the optical carrier and even components (i.e., components at ω₀+2mωₑ, mεZ) after the combiner. The phase noise reduced component and the component with twice the phase noise will appear as imaginary signals at point (5). Similarly, even components at the output of the bottom MZI are suppressed [point (6)]. By shifting the phase of the optical field by 90° in the top arm, and combining it with the optical field of the bottom arm, the clean tone remains at the output spectrum of the SSB modulator.

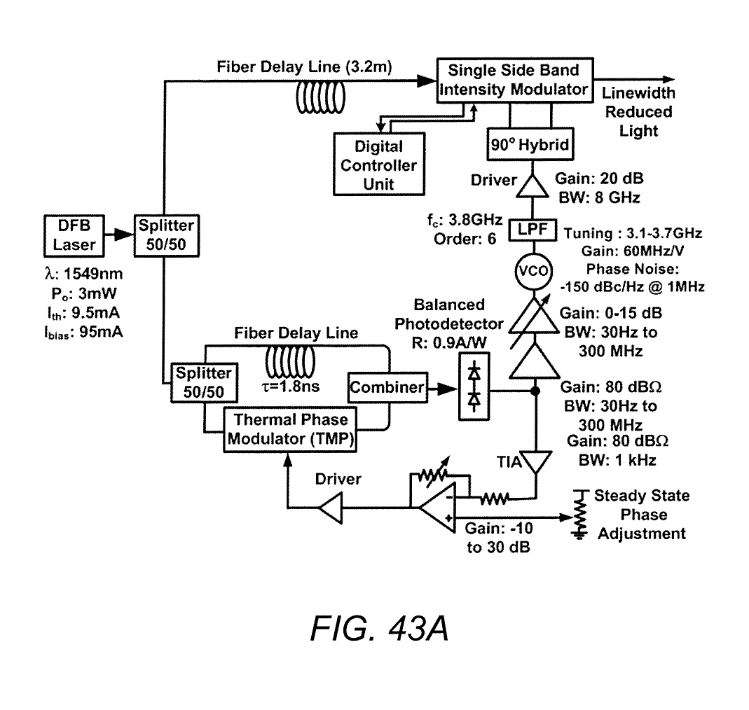

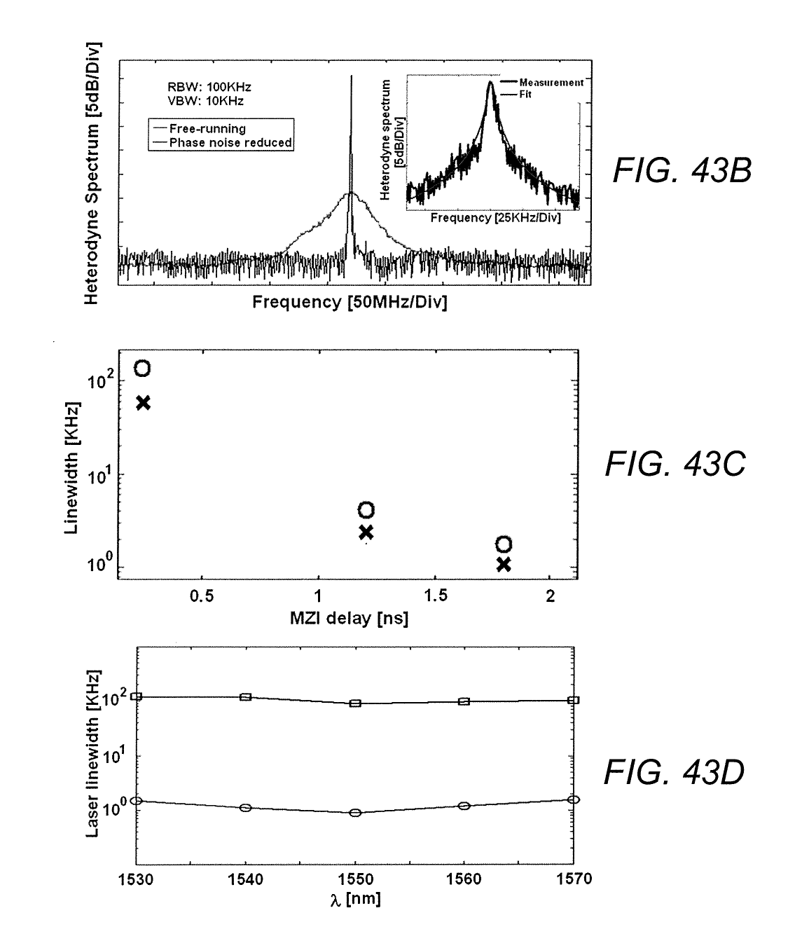

FIG. 43A illustrates a benchtop phase noise cancellation system. FIG. 43B illustrates the measured heterodyne spectrum of the laser before and after phase noise cancellation and its zoomed-in version (the inset). FIG. 43C illustrates the measured and calculated effect of the MZI delay on the minimum achievable linewidth (the calculation is based on 37 pA/\sqrt{Hz} input referred current noise of electronic circuitry dominating the photodiode shot noise and the laser intensity noise after balanced detection). FIG. 43D illustrates the measured highly tunable linewidth reduction capability of the proposed phase noise cancellation system.

FIG. 43A shows the fiber-based benchtop setup for the proposed phase noise cancellation scheme. A fiberbased MZI with delay difference of τ=1.8 ns was used in the feed-forward path to discriminate the frequency noise of a commercially available distributed feedback (DFB) laser emitting at 1549 nm. An analog slow loop with 10 Hz bandwidth was used to correct for the slowly varying thermal fluctuations between two arms of the MZI through a thermal phase modulator (as explained in [6]). A balanced photodetector with responsivity of 0.9 A/W was built using two similar Thorlabs FGA04 photodiodes and used after the frequency noise discriminator to suppress the laser intensity noise by more than 16 dB. A Minicircuits ZX95-3555+VCO oscillating at 3.2 GHz with 600 MHz modulation bandwidth was used to integrate the laser frequency noise in the phase domain. A Minicircuits ZX10Q-2-34-S 90° power splitter was used to generate inphase and quadrature signals from VCO output. A JDS Uniphase LiNbO₃ traveling wave differential quadrature phase shift keying modulator was used as the SSB modulator. The entire setup was placed inside an aluminum box with a layer of thermally isolating foam attached to its inside walls to minimize the effect of environment thermal fluctuations. Once the delay mismatch between the main path and the feed-forward path is adjusted (by adding 3.2 m of single mode optical fiber), and the gain of the feed-forward path is adjusted in the electrical domain, the spectrum of the SSB modulator is downconverted to electrical domain by beating it with a 400 Hz linewidth Orbits Lightwave fiber laser [FIG. 43B]. The heterodyne scheme shows that a laser linewidth of 7.5 MHz is reduced to 1.8 kHz when the intensity of the light at the input of the phase noise cancellation system was set to 3 mW [see FIG. 43B inset].

Effects of gain and delay mismatch between the feed-forward path and the main path are similar to those covered in [6]. The phase noise cancellation bandwidth is mainly limited by the first null in the MZI response (equivalent to τ⁻¹) and the bandwidth of the electronic circuits. Frequency noise reduction of more than 30 dB up to 20 MHz and more than 10 dB up to 100 MHz was observed after the phase noise cancellation system.

Ideally, the phase noise of the laser is discriminated in the feed-forward path and fully canceled. However, laser intensity noise and noise of the photodetector and electronic circuitry limit the smallest achievable linewidth. Assuming that the total electrical and optical amplitude noise (i.e., the laser intensity noise, the photodetector shot noise, and the noise of electronic circuitry) can be modeled as a current noise referred to the input of the electronic circuitry, iₙ, the minimum linewidth of the output component of the VCO-based feed-forward linewidth reduction scheme can be written as

$${C}_{canceled} \geq {C}_{e} + {( \frac{2}{{RI}_{0} τ} )}^{2} \overline{{i}_{n}^{2}} . \\ where \overline{{i}_{n}^{2}} \qquad ( 57 )$$

is the power spectral density of additive amplitude noise and Cₑ is the linewidth of the VCO (e.g., the −3 dB linewidth of an oscillator with phase noise of −140 dBc/Hz at 1 MHz offset is about 100 mHz).

Equation (57) indicates that, although decreasing the MZI delay, τ, results in higher phase noise cancellation bandwidth, it increases the required feed-forward gain, resulting in more injected amplitude noise and, therefore, larger achievable linewidth. To investigate this effect, the delay difference between two arms of the frequency discriminator MZI is varied (by changing the length of the fiber delay line) while the laser outputpower is kept constant at 3 mW. After compensating for the delay mismatch between the main path and the feed-forward path and adjusting the feed-forward gain for each measurement, the laser linewidth at the output of the feed-forward phase noise cancellation system is measured and is depicted in FIG. 43C. The measured linewidth in FIG. 43C is inversely proportional to the MZI delay squared [Eq. (57)].

In a different experiment, the proposed phase noise cancellation system is placed after a HP8168F tunable laser. The wavelength of the tunable laser is swept from 1530 to 1570 nm while its output power is kept at 3 mW. FIG. 43D shows the linewidth of the laser before and after phase noise cancellation at different wavelengths. By placing the phase noise cancellation system after the tunable laser, a narrow linewidth tunable light source can be realized.

In summary, a wideband laser phase noise reduction scheme has been introduced where the optical field of a laser is single sideband modulated with an electrical signal containing the discriminated phase noise of the laser. The proof-of-concept experiments on a commercially available 1549 nm distributed feedback laser show linewidth reduction from 7.5 MHz to 1.8 kHz without using large optical cavity resonators. This feed-forward scheme performs wideband phase noise cancellation independent of the light source and, as such, it is compatible with the original laser source tunability without requiring tunable optical components. By placing the proposed phase noise reduction system after a commercial tunable laser, a tunable coherent light source with kilohertz linewidth over a tuning range of 1530-1570 nm is demonstrated.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A laser phase noise reduction system for reducing phase noise in a laser field generated by a laser comprising:
a phase-frequency discriminator configured to receive a first portion of the laser field and to generate an electrical output that includes information about the phase or frequency of the laser field;
an electrical filter configured to receive the electrical output of the phase-frequency discriminator and to generate an electrical signal that represents the electrical output of the phase-frequency discriminator filtered by a filtering criteria; and
a phase modulator configured to receive a second portion of the laser field different from the first portion of the laser field and to modulate the second portion of the laser field with the electrical signal from the electrical filter, thereby reducing phase noise in the second portion of the laser field.

2. The laser phase noise reduction system of claim 1 wherein the phase-frequency discriminator is resonator-based.

3. The laser phase noise reduction system of claim 2 wherein the resonator-based phase-frequency discriminator includes a resonator coupled to a waveguide.

4. The laser phase noise reduction system of claim 1 further comprising a feedback laser phase noise reduction system configured to reduce the phase noise in the laser field.

5. A laser phase noise reduction system for reducing phase noise in a laser field generated by a laser comprising:
a frequency discriminator configured to receive a first portion of the laser field and to generate an electrical output that includes information about the frequency of the laser field;
a voltage or current controlled oscillator configured to receive the electrical output of the frequency discriminator and to generate an oscillation that has a frequency that is a function of the electrical output of the frequency discriminator; and
an amplitude modulator configured to receive the oscillation from the voltage or current controlled oscillator and to modulate the amplitude of a second portion of the laser field with the oscillation from the oscillator, thereby reducing phase noise in the second portion of the laser field.

6. The laser phase noise reduction system of claim 5 wherein the amplitude modulator is a quadrature or single sideband amplitude modulator.

7. The laser phase noise reduction system of claim 5 wherein the frequency discriminator is a delay-line discriminator.

8. The laser phase noise reduction system of claim 5 further comprising a feedback laser phase noise reduction system configured to reduce the phase noise in the laser field.

9. A laser phase noise reduction system for reducing phase noise in a laser field generated by a laser comprising:
a first laser phase noise reduction system configured to reduce a first portion of the phase noise; and
a second laser phase noise reduction system configured to reduce a second portion of the phase noise that is different from the first portion after the reduction of the first portion of the phase noise by the first laser phase noise reduction system.

10. The laser phase noise reduction system of claim 9 wherein the first or the second laser phase noise reduction system includes:
a phase-frequency discriminator configured to receive a first portion of the laser field and to generate an electrical output that includes information about the phase or frequency of the laser field;
an electrical filter configured to receive the electrical output of the phase-frequency discriminator and to generate an electrical signal that represents the electrical output of the phase-frequency discriminator filtered by filtering criteria; and
a phase modulator configured to receive a second portion of the laser field different from the first portion of the laser field and to modulate the second portion of the laser field with the electrical signal from the electrical filter.

11. The laser phase noise reduction system of claim 9 wherein the first or the second laser phase noise reduction system includes:
a frequency discriminator configured to receive a first portion of the laser field and to generate an electrical output that includes information about the frequency of the laser field;
a voltage or current controlled oscillator configured to receive the electrical output of the frequency discriminator and to generate an oscillation that has a frequency that is a function of the electrical output of the frequency discriminator; and
an amplitude modulator configured to receive the oscillation from the voltage or current controlled oscillator and to modulate the amplitude of a second portion of the laser field with the oscillation from the oscillator.

12. A laser phase noise reduction system configured to receive laser fields generated by a tunable laser that have a range of different wavelengths and that is configured to reduce phase noise in all of those laser fields across the range of the different wavelengths.

13. The laser phase noise reduction system of claim 12 wherein the laser phase noise reduction system includes:
a phase-frequency discriminator configured to receive a first portion of the laser field and to generate an electrical output that includes information about the phase or frequency of the laser field;
an electrical filter configured to receive the electrical output of the phase-frequency discriminator and to generate an electrical signal that represents the electrical output of the phase-frequency discriminator filtered by filtering criteria; and
a phase modulator configured to receive a second portion of the laser field different from the first portion of the laser field and to modulate the second portion of the laser field with the electrical signal from the electrical filter.

14. The laser phase noise reduction system of claim 12 wherein the laser phase noise reduction system includes:
a frequency discriminator configured to receive a first portion of the laser field and to generate an electrical output that includes information about the frequency of the laser field;
a voltage or current controlled oscillator configured to receive the electrical output of the frequency discriminator and to generate an oscillation that has a frequency that is a function of the electrical output of the frequency discriminator; and
an amplitude modulator configured to receive the oscillation from the voltage or current controlled oscillator and to modulate the amplitude of a second portion of the laser field with the oscillation from the oscillator thereby reducing phase noise in the second portion of the laser field.

15. A laser phase noise reduction system for reducing phase noise in a laser field generated by a laser comprising:
a feed-forward laser phase noise reduction system configured to reduce the phase noise in the laser field; and
a feedback laser phase noise reduction system configured to reduce the phase noise in the laser field.

16. The laser phase noise reduction system of claim 15 wherein the feed-forward or the feedback laser phase noise reduction system includes:
a phase-frequency discriminator configured to receive a first portion of the laser field and to generate an electrical output that includes information about the phase or frequency of the laser field;
an electrical filter configured to receive the electrical output of the phase-frequency discriminator and to generate an electrical signal that represents the electrical output of the phase-frequency discriminator filtered by filtering criteria; and
a phase modulator configured to receive a second portion of the laser field different from the first portion of the laser field and to modulate the second portion of the laser field with the electrical signal from the electrical filter.

17. The laser phase noise reduction system of claim 15 wherein the feed-forward or the feedback laser phase noise reduction system includes:
a frequency discriminator configured to receive a first portion of the laser field and to generate an electrical output that includes information about the frequency of the laser field;
a voltage or current controlled oscillator configured to receive the electrical output of the frequency discriminator and to generate an oscillation that has a frequency that is a function of the electrical output of the frequency discriminator; and
an amplitude modulator configured to receive the oscillation from the voltage or current controlled oscillator and to modulate the amplitude of a second portion of the laser field with the oscillation from the oscillator.

18. The laser phase noise reduction system of claim 15 wherein the feed-forward and the feedback laser phase noise reduction systems each have an input configured to receive at least a portion of the same laser field.

19. The laser phase noise reduction system of claim 15 wherein the feed-forward laser phase noise reduction system produces at an output the laser field with reduced phase noise and wherein the feedback laser phase noise reduction system has an input configured to receive a portion of the output from the feed-forward laser phase noise reduction system.

20. The laser phase noise reduction system of claim 15 wherein the feed-forward and the feedback laser phase noise reduction systems share a common phase discriminator.
